(19) United States
(12) Patent Application Publication
(10) Pub. No.: US 2024/0314184 A1
(43) Pub. Date: Sep. 19, 2024

(54) DATA TRANSMISSION METHOD, APPARATUS, AND SYSTEM, DEVICE, AND STORAGE MEDIUM

(71) Applicant: TENCENT TECHNOLOGY (SHENZHEN) COMPANY LIMITED, Shenzhen (CN)

(72) Inventors: Liuwen HUANG, Shenzhen (CN); Di XUE, Shenzhen (CN); Ling LI, Shenzhen (CN); Junyao LI, Shenzhen (CN); Yu HE, Shenzhen (CN)

(21) Appl. No.: 18/671,551

(22) Filed: May 22, 2024

Related U.S. Application Data
(63) Continuation of application No. PCT/CN2023/099890, filed on Jun. 13, 2023.

(30) Foreign Application Priority Data
Aug. 18, 2022 (CN) 202210995103.0

(51) Int. Cl. H04L 65/611; H04L 67/1001

(52) U.S. Cl. CPC H04L 65/611; H04L 67/1001

(57) ABSTRACT

A data transmission method includes obtaining an allocation request of a client for a media access machine; in response to the allocation request, determining, from a plurality of media access service areas and according to first-level load information of each of the media access service areas, a target media access service area to which the client is to be connected; determining, from a plurality of media access machines corresponding to the target media access service area and according to second-level load information of the target media access service area, a target media access machine to which the client is to be connected; and allocating the target media access machine to the client for media data transmission between the client and the target media access machine.

### CROSS-REFERENCE TO RELATED APPLICATIONS

This application is a continuation of International Application No. PCT/CN2023/099890, filed on Jun. 13, 2023, which claims priority to Chinese Patent Application No. 202210995103.0, entitled “DATA TRANSMISSION METHOD, APPARATUS, AND SYSTEM, DEVICE, AND STORAGE MEDIUM” filed with the State Intellectual Property Office of the People's Republic of China on Aug. 18, 2022, the entire contents of which are incorporated by reference.

### FIELD OF THE TECHNOLOGY

This application relates to the field of Internet technologies, and in particular, to a data transmission method, apparatus, and system, a computer device, a computer readable storage medium, and a computer program product.

### BACKGROUND OF THE DISCLOSURE

With the rapid development of computer and Internet technologies, various real-time audio and video technologies have brought great convenience to the people's daily life, such as live scenes, online classes, online meetings, group live broadcasts, and so on. Getting information or shopping online by watching live broadcasts has become more and more popular.

At present, for the machine scheduling strategy in various real-time audio and video scenes, the load information of all machine resources in a system is generally pulled by a unified machine resource load management server. However, due to the limited number of machines managed by the machine resource load management server, the maximum number of participating members meets a bottleneck problem, which will affect the number of objects supported to be connected by a single streaming media in a high concurrency scene. Accordingly, the number of objects supported by the whole system is limited. Moreover, every time the machine resource load manager receives a request to join, it needs to query the load status of each machine in real time. This series of processing flows cause the strategy scheduling service allocating machine to have a long time consumption and a low processing performance.

### SUMMARY

In accordance with the disclosure, there is provided a data transmission method including obtaining an allocation request of a client for a media access machine; in response to the allocation request, determining, from a plurality of media access service areas and according to first-level load information of each of the media access service areas, a target media access service area to which the client is to be connected; determining, from a plurality of media access machines corresponding to the target media access service area and according to second-level load information of the target media access service area, a target media access machine to which the client is to be connected; and allocating the target media access machine to the client for media data transmission between the client and the target media access machine.

Also in accordance with the disclosure, there is provided a data transmission system including a client, a scheduling server, a first-level load management server, and a second-level load management server located in each of one or more media access service areas determined by division according to geographical region. The second-level load management server located in each media access service area is configured to push second-level load information of the corresponding media access service area to the first-level load management server. The first-level load management server is configured to push first-level load information corresponding to each media access service area to the scheduling server. The scheduling server is configured to obtain an allocation request of a client for a media access machine; in response to the allocation request, determine, from a plurality of media access service areas and according to first-level load information of each of the media access service areas, a target media access service area to which the client is to be connected; determine, from a plurality of media access machines corresponding to the target media access service area according to the second-level load information of the target media access service area, a target media access machine to which the client is to be connected; and allocate the target media access machine to the client for media data transmission between the client and the target media access machine.

Also in accordance with the disclosure, there is provided a computer device including one or more processors and one or more memories storing one or more program instructions that, when executed by the one or more processors, cause the one or more processors to: obtain an allocation request of a client for a media access machine; in response to the allocation request, determine, from a plurality of media access service areas and according to first-level load information of each of the media access service areas, a target media access service area to which the client is to be connected; determine, from a plurality of media access machines corresponding to the target media access service area and according to second-level load information of the target media access service area, a target media access machine to which the client is to be connected; and allocate the target media access machine to the client for media data transmission between the client and the target media access machine.

### BRIEF DESCRIPTION OF THE DRAWINGS

To describe the technical solutions of the embodiments of this application more clearly, the accompanying drawings required for describing the embodiments are described briefly hereinafter. Apparently, the accompanying drawings in the following description show only some embodiments of this application, and other drawings can be obtained by a person of ordinary skill in the art from these accompanying drawings without creative efforts.

FIG. 1 is a schematic diagram of an audio-video architecture in related art according to an embodiment.

FIG. 2 shows an application environment of a data transmission method according to an embodiment.

FIG. 3 is a schematic flowchart of a data transmission method according to an embodiment.

FIG. 4 shows the data statistics of time consumption for media access machine requesting according to an embodiment.

FIG. 5 is a schematic diagram showing two-level load query according to an embodiment.

FIG. 6 shows the data statistics showing time consumption for first-frame audio/video decoding according to an embodiment.

FIG. 7 is a schematic diagram showing signaling notification according to an embodiment.

FIG. 8 is a schematic diagram showing target media stream pulling according to an embodiment.

FIG. 9 is a schematic diagram of a data transmission system architecture according to an embodiment.

FIG. 10 is a structural block diagram of a data transmission apparatus according to an embodiment.

FIG. 11 is a diagram of an internal structure of a computer device according to an embodiment.

### DESCRIPTION OF EMBODIMENTS

To make the objects, technical solutions, and advantages of this application clearer, this application is further described in detail below with reference to the accompanying drawings and embodiments. The specific embodiments described herein are only used for explaining this application, instead of limiting this application.

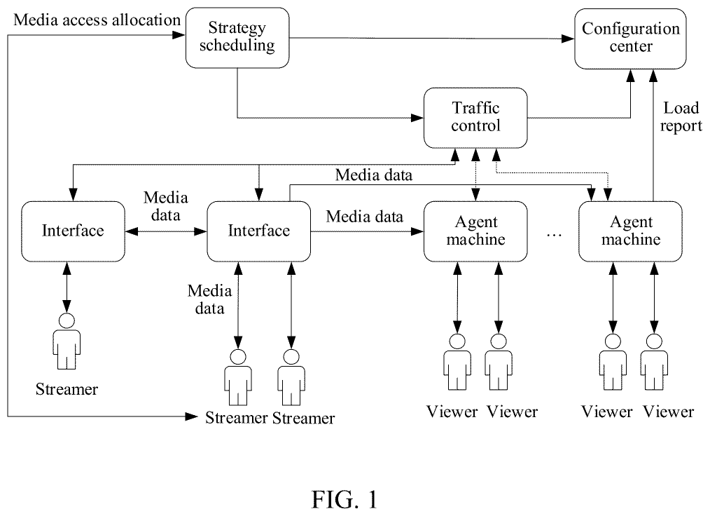

In the related art, as shown in FIG. 1, a configuration center performs load management of each machine resource. A stream control, an interface machine and a proxy machine report the load to the configuration center periodically. The configuration center provides a pull service of the load status of these machine resources and the determination of the machine on/off state. A user sends a media access allocation request, and a strategy scheduler authenticates the media access allocation request, and pulls the load information through the configuration center to determine a media access machine for the user client. In this case, in the related art, a corresponding media access machine is allocated to the user according to whether the user has uplink permission or not. For example, when the user is a streamer having the uplink permission, an interface machine that can uplink and downlink real-time media data will be allocated to the user. When the user is a viewer having no uplink permission, an agent machine will be allocated to the user to receive the media data of the interface machine. Therefore, centralized reporting-type first-level server load management as shown in FIG. 1 is employed. That is, the traffic control, the interface machine and the agent machine report the load to the configuration center periodically, and the strategy scheduler pulls the load information of the stream control, the interface machine and the agent machine from the configuration center periodically. In this case, the configuration center tends to become a bottleneck, and the number of the traffic control, the interface machine and the agent machine it can manage is limited, affecting the number of users supported by a single large room and the number of users supported by the whole system. As a result, the number of objects supported to be connected by a single streaming media is affected in a high concurrency scene. Accordingly, the number of objects supported by the whole system is limited. Moreover, every time the configuration center receives a request to join, it needs to query the load status of each machine in real time. This series of processing flows cause the strategy scheduling service allocating machine to have a long time consumption and a low processing performance.

According to a data transmission method provided in an embodiment of this application, a target media access service area corresponding to a client is determined according to first-level load information of multiple media access service areas, in response to an allocation request. According to second-level load information of the target media access service area, a target media access machine in the target media access service area to which the client is to be connected is quickly and accurately determined, so as to transmit media data between the client and the target media access machine. In this way, by performing load management according to the media access service area, the load management of different machines at different levels is realized, and the aggregation scheduling at a single machine level can be transformed into the aggregation scheduling of media access service areas with a higher processing power, thus avoiding the excessive aggregation of single machines, improving the high concurrency and system performance, simplifying the whole scheduling process of the media access machine, and thus improving the scheduling efficiency.

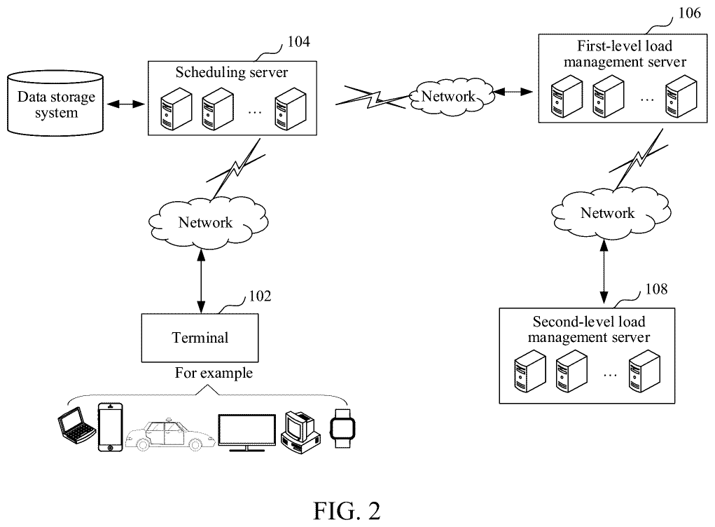

The data transmission method provided in the embodiment of this application is applicable in an application environment as shown in FIG. 2. A terminal 102 communicates with a scheduling server 104 (that is, a computer device) through a network. A first-level load management server 106 communicates with the scheduling server 104 through a network. A second-level load management server 108 communicates with the first-level load management server 106 through a network. A data storage system can store data that the scheduling server 104 needs to process. The data storage system can be integrated on the scheduling server 104, or on the cloud or other servers.

In some embodiments, the scheduling server 104 obtains an allocation request of a client deployed on the terminal 102 for a media access machine. In response to the allocation request, the scheduling server 104 determines a target media access service area to which the client is to be connected from multiple media access service areas according to first-level load information of each of the media access service areas; determines a target media access machine to which the client is to be connected from multiple media access machines corresponding to the target media access service area according to second-level load information of the target media access service area; and allocates the target media access machine for the client to transmit media data between the client and the target media access machine.

This application involves the scheduling server 104, the first-level load management server 106, the second-level load management server 108, and others. The server can be an independent physical server, a server cluster or a distributed system including multiple physical servers, or a cloud server providing basic cloud computing services such as cloud services, cloud databases, cloud computing, cloud functions, cloud storage, network services, cloud communication, middleware services, domain name services, security services, CDN, big data and artificial intelligence platforms. The terminal 102 may be a smart phone, a tablet computer, a notebook computer, a desktop computer, a smart speaker, a smart watch, or the like, but is not limited thereto. The terminal 102 and the server can be connected directly or indirectly through wired or wireless communication, which is not limited in this application.

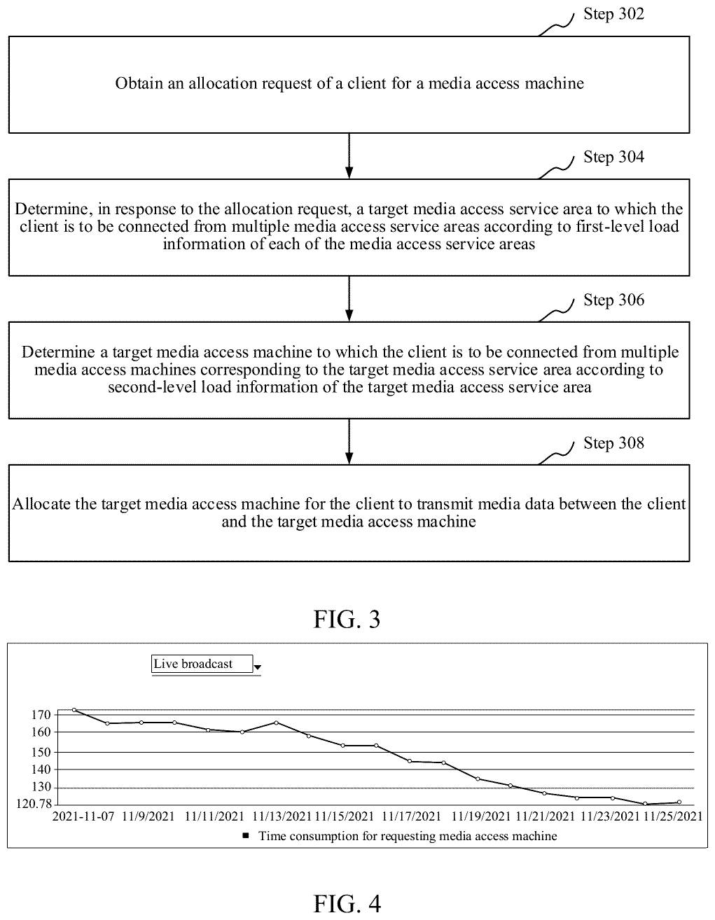

In some embodiments, as shown in FIG. 3, a data transmission method is provided. Description is made by way of example in which the method is applicable to the scheduling server 104 in FIG. 2. The method includes the following operations:

Operation 302: Obtain an allocation request of a client for a media access machine.

The allocation request for a media access machine is a request for allocating a media access machine to the client, so that the client can uplink or downlink media data with the media access machine, that is, receives media data sent from the media access machine or uplinks media data to the media access machine. Uplinking media data means to upload the media data. In an embodiment of this application, the media access machine is a server receiving media data uploaded by the client or sending media data to the client. The media data can be video data, image data, and sound data, etc. In some embodiments, in a live broadcast scene, when a streamer or a viewer enters a live broadcast room, the client where the streamer or the audience is located needs to be connected to a server, that is, the media access machine herein. The streamer can upload or pull live broadcast picture data by using the connected media access machine, and the viewer can pull the live broadcast picture data by using the connected media access machine.

For example, in a real-time audio and video scene, the media access machine can uplink or downlink audio and video data for a client having uplink permission or send audio and video data for a client having no uplink permission. The media access machine can also be used to convert a client having no uplink permission into a client having uplink permission. The uplink permission refers to the permission to upload audios and videos, and uplinking or downlinking audio and video data means to upload audio and video data and download audio and video data.

Specifically, a scheduling server obtains an allocation request of a client for a media access machine. The allocation request carries a streaming media identifier to be connected by the client and a client identifier. The streaming media identifier can be used to uniquely identify a streaming media. For example, the streaming media identifier can be an identifier of a live broadcast room (room ID) in a live broadcast scene, a meeting ID of a meeting in an online meeting scene, or a multi-person group ID in a multi-person audio-video call scene, which is not particularly limited. Streaming media is a virtual space that multiple accounts enter when they interact with respect to a same topic. For example, in a live broadcast scene, the streaming media can be a live broadcast room. In an online meeting scene, the streaming media can be a meeting room. In a multi-person audio-video call scene, the streaming media is a multi-person group.

In some embodiments, a terminal generates an allocation request carrying a streaming media identifier to be connected by the client and a client identifier, in response to a user's trigger operation on the client. The terminal sends the allocation request to a subcontract-layer server, and the subcontract-layer server determines a target cluster according to the streaming media identifier or the client identifier in the allocation request. The subcontract-layer server sends the allocation request carrying the streaming media identifier to be connected by the client and the client identifier to a scheduling server in the target cluster, and the scheduling server obtains the allocation request of the client for a media access machine.

For example, the subcontract-layer server is pre-configured with clusters respectively corresponding to multiple streaming media identifier intervals. The subcontract-layer server determines a streaming media identifier interval where the streaming media identifier resides according to the streaming media identifier in the allocation request, and determines a target cluster according to the streaming media identifier interval. The subcontract-layer server is configured to determine a cluster to which the client belongs. Each cluster uniquely corresponds to a scheduling server. A cluster refers to a collection of clients with the same business requirements. For example, clients with financial business requirements are gathered in a financial cluster.

For example, a first streaming media identifier interval includes streaming media identifier Nos. 1 to 500, and the first streaming media identifier interval corresponds to a first major customer cluster. A second streaming media identifier interval includes streaming media identifier Nos. 501 to 1000, and the second streaming media identifier interval corresponds to a second major customer cluster. The subcontract-layer server parses the received allocation request and determines that the streaming media identifier carried in the allocation request is No. 3. In this case, the subcontract-layer server determines that the target cluster is the first major customer cluster. For example, the subcontract-layer server is pre-configured with clusters respectively corresponding to different business. For example, the financial business corresponds to a financial cluster. The non-financial business corresponds to a default cluster. The subcontract-layer server parses the received allocation request and determines that the client identifier carried in the allocation request is a financial identifier. In this case, the target cluster is determined to be a financial cluster.

An appropriate cluster is selected from the pre-configured clusters for the client by the subcontract-layer server according to the streaming media identifier or the client identifier. For example, a target cluster that matches a job attribute of a user who logs in to the client can be selected according to the job attribute, thus ensuring that the scheduling of the media access machine can be implemented through the scheduling server of the target cluster in the future, and improving the effectiveness of the scheduling of the media access machine. In addition, it can prevent the aggregation of all clients in the same cluster, that is, the processing of all allocation requests by one scheduling server, thus effectively improving the scheduling efficiency of the media access machines.

Operation 304: Determine, in response to the allocation request, a target media access service area to which the client is to be connected from multiple media access service areas according to first-level load information of each of the media access service areas.

The media access service area is a set of machines, including machines for managing streaming media and machines for managing load information. Each cluster involves clients in different regions, so the machine scheduling of each cluster will involve the load management of machines in at least one region. To facilitate the load management of machines in different regions, the media access service areas respectively corresponding to different regions are determined by division according to the region.

Based on this, in some embodiments, the media access service areas are obtained by division according to regions. The region refers to a physical region. The division according to regions refers to dividing a preset physical region to obtain divided regions. Each of the divided regions corresponds to at least one media access service area, and at least one machine is connected in each media access service area, where the machine can be a media access machine. For example, for a divided region that is Chengdu region, there is a media access service area corresponding to Chengdu region.

In an embodiment of this application, the media access machines are divided into different areas according to the region, and the aggregation scheduling and load management are carried out according to each media access area. Real-time media data retrieval can be achieved when needed between media access areas and in the same media access area, so as to support the high concurrency access scene, support the smooth connection of connected objects to the microphone at the same time, and effectively reduce the bandwidth cost of data transmission between media access machines, thus being suitable for a very-large real-time audio and video scene. In some embodiments, the determining, in response to the allocation request, a target media access service area to which the client is to be connected from multiple media access service areas according to first-level load information of each of the media access service areas, includes: determining, in response to the allocation request, a target media access service area to which the client is to be connected from multiple media access service areas according to first-level load information corresponding to each of the media access service areas that are obtained by division according to region, where the first-level load information is pushed by a first-level load management server.

The machines involved in each cluster include at least one load management server and at least one media access machine. The load management server is a server that performs load management of machines in at least one media access service area. For example, one load management server can perform load management of media access machines in all media access service areas. For example, each load management server can perform load management of all media access machines in a corresponding media access service area.

Optionally, the load management server includes a first-level load management server and a second-level load management server. Optionally, each cluster corresponds to one scheduling server, and each cluster includes at least one media access service area. Each media access service area has at least one corresponding second-level load management server. Each second-level load management server obtains load information of at least one machine in the media access service area to which it belongs, and sends the load information of the media access service area to the first-level load management server. The first-level load management server pushes the load information of multiple media access service areas to the scheduling server of the cluster. Illustratively, each media access service area includes at least one second-level load management server and at least one media access machine.

Because the machine scheduling of each cluster will involve the load management of machines in at least one region, if the scheduling server is used to perform load management of machines in all regions in the cluster, the scheduling server will easily become a bottleneck at this time, thus reducing the scheduling efficiency. Based on this, the second-level load management server queries the load information of the machines in the corresponding media access service area and reports it to the first-level load management server. In this way, the first-level load management server can directly obtain the load information of different media access service areas. Then, the first-level service management server pushes the obtained load information to the scheduling server. As a result, the load information of different machines in the cluster is managed at different levels by using two-level load query, which effectively reduces the management pressure of the scheduling server, and also ensures that the scheduling server can obtain all the scheduling information of the cluster in time for scheduling, thus improving the scheduling efficiency.

As mentioned above, the load management server is a server that performs load management of machines in at least one media access service area. Then, in the process of load management by the load management server, the load management server will obtain the load information of at least one media access service area. The load information about the media access service area is used to characterize the load status of machines in the media access service area, such as the number of streaming media connected by the media access machine and the number of objects connected to the media access machine. For a single machine, the load information of the machine also includes at least one of CPU information and internal memory information of the machine. The machine includes at least one of a media access machine, a second-level streaming media management server, a first-level streaming media management server, a first-level load management server and a second-level load management server.

In some embodiments, the load information about the media access service area includes first-level load information and second-level load information. The second-level load information is used to characterize the load information of a corresponding media access service area, and the second-level load information is used to characterize the load information of an individual media access service area.

For the first-level load information, the first-level load information includes the load information of machines in the media access service areas. In some embodiments, the first-level load information is determined by the second-level load information respectively corresponding to the media access service areas. For example, the first-level load information can include the second-level load information respectively corresponding to the media access service areas, or can be a ranking result obtained by ranking the pieces of second-level load information, which is not particularly limited. In some embodiments, the first-level load information includes the number of connected objects and the number of connected streaming media served by each media access service area, and the media access resources corresponding to each media access service area. In addition, the first-level load information includes, in addition to the media access resources in each media access service area, the media access resources of the first-level load management server. The number of connected objects can be understood as the number of connected clients. In some embodiments, the number of connected streaming media in a live broadcast scene can be understood as the number of live broadcast rooms in the live broadcast scene. In an online meeting scene, the number of connected streaming media can be understood as the number of meeting rooms in the online meeting. The media access resources can be understood as central processing unit (CPU) information and internal memory information of the server. For example, the media access resources in the first-level load information include the CPU information and internal memory information of the first-level load management server, the CPU information and internal memory information of the second-level load management server in each media access service area, and the CPU information and memory information of the media access machines. For each media access service area, the media access resources in the second-level load information include the CPU information and internal memory information of the second-level load management server, and the CPU information and internal memory information of the media access machines.

For the second-level load information, optionally, the second-level load information includes the load information of all media access machines in a corresponding media access service area, and the load information of the media access machine includes at least one of the number of objects connected to the media access machine and the number of connected streaming media. Illustratively, the second-level load information includes the number of connected objects and the number of connected streaming media served by a corresponding media access service area, and at least one of the CPU information and internal memory information of the second-level load management server and the CPU information and internal memory information of the media access machines in the corresponding media access service area.

Further, in some embodiments, the machines involved in the cluster also include at least one streaming media management server. The streaming media management server is a server that manages at least one streaming media. Optionally, one streaming media management server can manage the streaming media in all the media access service area. Optionally, each streaming media management server can manage all the streaming media in a corresponding media access service area.

Optionally, the streaming media management server includes a first-level streaming media management server and a second-level streaming media management server. For each streaming media access service area, the media access service area also includes at least one second-level streaming media management server. Each second-level streaming media management server is a server that manages the streaming media in the media access service area. As mentioned above, each media access service area also includes a corresponding second-level load management server. The second-level load management server is a server for managing the second-level streaming media management server and the media access machines in the media access service area. The first-level streaming media management server is configured to manage the second-level streaming media management server in each media access service area.

In the process of managing the streaming media by the streaming media management server, the streaming media management server will obtain streaming media information of at least one media access service area. The streaming media information characterizes the number of streaming media connected by the media access machine and the number of connected objects to each streaming media.

Optionally, the streaming media information includes first-level streaming media information and second-level streaming media information. The second-level streaming media information characterizes the number of streaming media and the number of connected objects served by a corresponding media access service area. The first-level streaming media information characterizes the number of streaming media and the number of connected objects served by each media access service area. Since the second-level load management server is a server configured to manage the second-level streaming media management server and the media access machines in the media access service area, the second-level load information includes the second-level streaming media information. Since the first-level streaming media management server is configured to manage the second-level streaming media management server in each media access service area, the first-level streaming media information includes the second-level streaming media information.

Of course, the first-level load management server is further configured to receive the first-level streaming media information of the first-level streaming media management server in the cluster, and periodically send the collected first-level streaming media information to the scheduling server of the cluster.

In this way, the streaming media can be effectively managed by the streaming media management server. Further, all the streaming media in the corresponding media access service area can be managed by the second-level streaming media management server to determine the streaming media management information of the media access service area. Based on this, if the scheduling server only needs to query relevant information of all the streaming media, the second-level streaming media information pushed by the second-level streaming media management server corresponding to each media access service area can be obtained by the first-level streaming media management server, to obtain the first-level streaming media information. Then, the first-level streaming media management server sends the first-level streaming media information to the first-level load management server, and the first-level load management server sends the first-level streaming media information to the scheduling server. If the scheduling server needs to query relevant information of the streaming media and relevant information of the media access machines, at this time, the second-level load management server can also obtain the second-level streaming media information of the second-level streaming media management server located in the same media access service area and reverent information of the media access machines located in the same media access service area, to obtain the second-level load information of the media access service area, and upload the second-level load information to the first-level load management server. The first-level load management server pushes the received second-level load information of each media access service area directly to the scheduling server, ensuring that the scheduling server can comprehensively and timely grasp the load information of all machines in the cluster. The second-level load management server and the second-level streaming media management server can both be deployed in a distributed pattern.

Specifically, the scheduling server determines the address where the client is located in response to the allocation request. According to the address of the client, the scheduling server determines the distance of the client to each media access service area. The media access service areas are obtained by division according to region. The scheduling server receives the first-level load information corresponding to each media service area that is pushed by the first-level load management server, and determines a target media access service area to which the client is to be connected according to the first-level load information and the distance of the client respectively to each media access service area.

For example, according to the distance of the client to each media access service area, the scheduling server sorts the distances in a sequence from near to far, and determines the serial number of each media access service area. The scheduling server takes a media access service area after the serial number of a previous media access service area as a current media access service area corresponding to a current iteration. The scheduling server determines the second-level load information of the current media access service area according to the first-level load information corresponding to each media access service area divided according to region pushed by the first-level load management server. The scheduling server determines a first occupation ratio of CPU, a second occupation ratio of the internal memory, a third occupation ratio of the number of the connected streaming media to the threshold number of streaming media and a fourth occupation ratio of the number of the connected objects to the threshold number of objects respectively from the number of the connected streaming media, the number of the connected objects, and the CPU information and internal memory information of the second-level load management server in the second-level load information of the current media access service area The scheduling server determines a current highest occupation ratio from the first occupation ratio, the second occupation ratio, the third occupation ratio and the fourth occupation ratio, and determines whether the current highest occupation ratio reaches a threshold ratio. If the scheduling server verifies that the current highest occupancy ratio does not reach the threshold ratio, it determines that the current media access service area is the target media access service area, and stops the iteration. If the scheduling server verifies that the current highest occupation ratio reaches the threshold ratio, a next iteration is performed, in which the current media access service area is used as a previous media access service area, and a media access service area after the serial number of the previous media access service area is returned and used as a current media access service area corresponding to a current iteration. The operation is performed again, until the current highest occupation ratio does not reach the threshold ratio, or the number of iterations reaches the number of the media access service areas. Then scheduling server takes the current media access service area corresponding to the current iteration as the target media access service area.

Operation 306: Determine a target media access machine to which the client is to be connected from multiple media access machines corresponding to the target media access service area according to second-level load information of the target media access service area.

The second-level load information includes the load information of the second-level streaming media management server and the load information of the media access machines in the target media access service area. The number of the connected objects served by the target media access service area is determined based on the number of the connected objects in the load information of the second-level streaming media management server and the number of the connected objects in the load information of the media access machines. Correspondingly, the number of the connected streaming media served by the target media access service area is determined based on the number of the connected streaming media in the load information of the second-level streaming media management server and the number of the connected streaming media in the load information of the media access machines.

In some embodiments, the determining a target media access machine to which the client is to be connected from multiple media access machines corresponding to the target media access service area according to the second-level load information of the target media access service area, includes: determining the target media access machine to which the client is to be connected from the media access machines in the target media access service area according to the second-level load information of the target media access service area. The second-level load information is pushed by the second-level load management server in the target media access service area to the first-level load management server.

For each media access service area, the second-level load management server of a corresponding media access service area is configured to collect the load status of the second-level streaming media management server and the media access machine of the corresponding media access service area. According to the CPU information and internal memory information of the second-level load management server and the CPU information and internal memory information of the media access machines in the target media access service area, the media access resources corresponding to the target media access service area are determined. The first-level load information is obtained by the first-level load management server receiving the second-level load information of all the media access service areas, and the second-level load information is obtained by the second-level load management server corresponding to each media access service area receiving the load information of the media access service area. Therefore, the first-level load information the first-level load information is obtained by summarizing the second-level load information corresponding to each media access service area. The first-level load management server directly pushes or reports the first-level load information to the scheduling server, while the second-level load management server does not directly face the scheduling server, and needs to report via the first-level load management server.

Specifically, the scheduling server obtains the second-level load information of the target media access service area, where the second-level load information is pushed to the first-level load management server by the second-level load management server in the target media access service area. The scheduling server determines the load information of each media access machine in the target media access service area which has the same identifier as the operator to which the client belongs according to the second-level load information, and determines the target media access machine by weighted randomization according to the load information of each media access machine. Optionally, the determining the target media access machine by weighted randomization according to the load information of each media access machine, includes: determining the weight of each media access machine according to the load information of each media access machine. The scheduling server randomly selects a media access machine as the target media access machine according to the weight of each media access machine. In the process of random selection, the greater the weight of the media access machine is, the higher the possibility that the media access machine is to be selected as the target media access machine will be.

For example, the scheduling server determines the load information of each media access machine in the target media access service area that has the same identifier as the operator to which the client belongs according to the second-level load information. For each media access machine, the scheduling server determines a highest occupation ratio of a corresponding media access machine according to a fifth occupation ratio of CPU, a sixth occupation ratio of the internal memory in the corresponding media access machine, a seventh occupation ratio of the number of connected streaming media to a threshold number of streaming media and an eighth occupation ratio of the number of connected objects to a threshold number of objects. The scheduling server determines the weight of each media access machine according to the highest occupation ratio respectively corresponding to each media access machine. The scheduling server randomly selects a media access machine as the target media access machine according to the weight of each media access machine.

Operation 308: Allocate the target media access machine for the client to transmit media data between the client and the target media access machine.

Specifically, the scheduling server sends the address of the target media access machine to the client, the client receives the address of the target media access machine sent by the scheduling server, and the client is connected to the target media access machine according to the address of the target media access machine, so as to transmit media data between the client and the target media access machine. For example, as shown in FIG. 4, in a live broadcast scene, in the scheduling of the media access machine from Nov. 7, 2021 to Nov. 25, 2021, the statistics of time consumption for requesting the media access machine decreases from 170 milliseconds to 120.78 milliseconds, that is, the time consumption is reduced by 50 milliseconds, and about 30%. Therefore, it is optimized from single machine aggregation to media access service area aggregation. Because the capacity of the media access service area is 100 times that of a single machine, the power to resist high concurrency is high, and the scheduling module does not need the process of load aggregation and over-aggregation prevention, which greatly optimizes the process complexity of scheduling and distribution.

In the data transmission method, the target media access service area corresponding to the client is determined according to the first-level load information of multiple media access service areas, in response to the allocation request. According to the second-level load information of the target media access service area, the target media access machine in the target media access service area to which the client is to be connected is quickly and accurately determined, so as to transmit media data between the client and the target media access machine. In this way, by performing load management according to the media access service area, the load management of different machines at different levels is realized, and the aggregation scheduling at a single machine level can be transformed into the aggregation scheduling of media access service areas with a higher processing power, thus avoiding the excessive aggregation of single machines, improving the high concurrency and system performance, simplifying the whole scheduling process of the media access machine, and thus improving the scheduling efficiency.

In some embodiments, the method further includes: receiving, by the first-level load management server, the second-level load information pushed by the second-level load management server, where the second-level load information includes the number of connected objects and the number of connected streaming media served by a corresponding media access service area, and the media access resources corresponding to the corresponding media access service area; collecting, by the first-level load management server, the second-level load information corresponding to each media access service area, to obtain the first-level load information, where the first-level load information includes the number of connected objects and the number of connected streaming medias served by each media access service area, and the media access resources corresponding to each media access service area; and receiving the first-level load information pushed by the first-level load management server.

Specifically, for each media access service area, the load information of the second-level streaming media management server and the load information of the media access machines in a corresponding media access service area are queried by the second-level load management server in the corresponding media access service area. The second-level load information corresponding to the corresponding media access service area is determined by the second-level load management server in the corresponding media access service area according to the load information of the second-level streaming media management server and the load information of the media access machines in the corresponding media access service area. The first-level load management server receives the second-level load information pushed by the second-level load management server. For each media access service area, the load information of the second-level streaming media management server in the corresponding media access service area includes the number of connected objects of the second-level streaming media management server, the number of connected streaming media and the media access resources of the second-level streaming media management server. The load information of the media access machine in the corresponding media access service area includes the number of connected objects and the number of connected streaming media to the media access machine and the media access resources of the media access machine. The second-level load information of each second-level load management server is received by the first-level load management server. The second-level load information corresponding to each media access service area is collected by the first-level load management server, to obtain the first-level load information including the number of connected objects and the number of connected streaming media served by each media access service area, and the media access resources corresponding to each media access service area.

The first-level load information can be periodically reported by the first-level load management server to the scheduling server, periodically queried and pushed by the first-level load management server to the scheduling server, or actively pushed by the first-level load management server to the scheduling server, which is not particularly limited. The second-level load information can be periodically reported by the second-level load management server to the first-level load management server, periodically queried and pushed by the second-level load management server to the first-level load management server, or actively pushed by the second-level load management server to the first-level load management server, or the second-level load information is pushed to the first-level load management server by the second-level load management server in response to a query request after the first-level load management server periodically actively queries the second-level load management server, which is not particularly limited.

When the first-level load management server periodically actively queries the second-level load management server for the second-level load information, and the second-level load management server pushes the second-level load information to the first-level load management server in response to the query request, because the first-level load management server actively queries the second-level load management server, it can avoid the situation that a large number of second-level load management servers push information to the first-level load management server concurrently in a large-scale scene, causing that the first-level load management server cannot handle it in time or even avalanche.

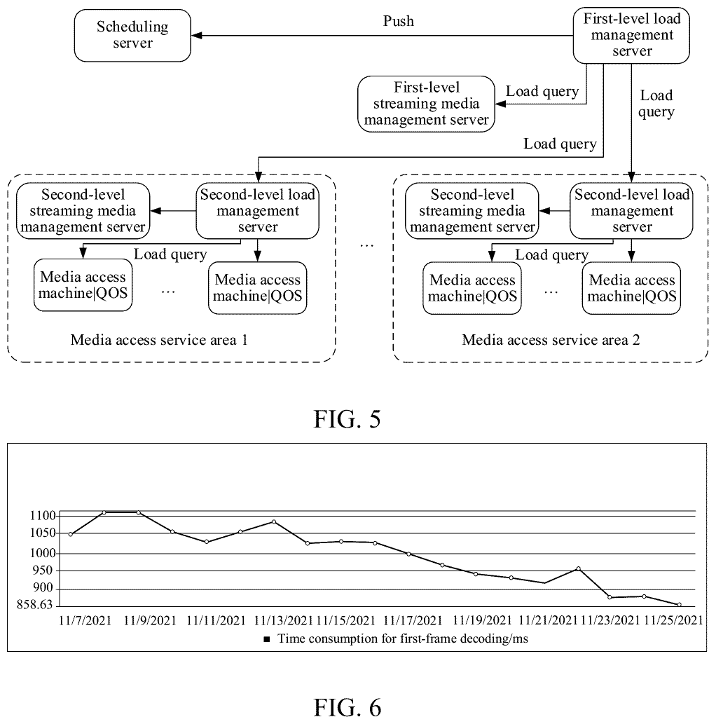

For example, as shown in FIG. 5, each media access service area includes at least one second-level streaming media management server, at least one second-level load management server and at least one media access machine. For each media access service area, the second-level load management server queries the load information of the media access service area and determines the second-level load information corresponding to the media access service area. The load information of the media access service area includes at least one of the CPU information and internal memory information of the media access machines and the second-level streaming media management server of the media access service area, and the number of streaming media connected by and the number of objects connected to the media access machines. The first-level load management server queries each media access service area, and the second-level load management server of each media access service area reports respective second-level load information to the first-level load management server. The first-level load management server determines the first-level load information according to the second-level load information corresponding to each media access service area, and pushes the first-level load information to the scheduling server. The second-level streaming media management server of each media access service area sends the second-level streaming media information of the media access service area to the first-level streaming media management server. If the first-level load management server queries the streaming media information, the first-level streaming media management server determines the first-level streaming media information according to the second-level streaming media information sent by each media access service area, and sends the first-level streaming media information to the first-level load management server.

For example, there are two media access service areas, namely a media access service area 1 and a media access service area 2. In the media access service area 1, the second-level load management server of the media access service area 1 periodically queries the second-level streaming media management server and the media access machines in the media access service area 1 for the load, to obtain the second-level load information corresponding to the media access service area 1. In the media access service area 2, the second-level load management server of the media access service area 2 periodically queries the second-level streaming media management server and the media access machines in the media access service area 2 for the load, to obtain the second-level load information corresponding to the media access service area 2. The process that the first-level streaming media management server periodically sends the first-level streaming media information to the first-level load management server will be described hereinafter. The first-level load management server obtains the second-level load information pushed by each second-level load management servers to obtain the first-level load information. The first-level load management server pushes the first-level load information to the scheduling server.

By deploying a quality of service (QOS) module in each media access machine, the quality of service of the media access machine can be regulated. Because the media access machines are deployed in a distributed pattern, the regulation of the quality of service is also managed in a distributed pattern, which reduces the calculation pressure and regulation pressure in the regulation of the quality of service.

In this embodiment, the first-level load management server receives the second-level load information collected by the second-level load management server of each media access service area and determines the first-level load information. That is, the load information corresponding to each level can be obtained in time by two-level load query, so that the first-level load information can be obtained quickly and accurately, which greatly improves the efficiency and accuracy of load query.

In some embodiments, the method further includes: receiving, by the first-level streaming media management server, the second-level streaming media information pushed by the second-level streaming media management server, where the second-level streaming media information includes the number of streaming media and the number of connected objects served by a corresponding media access service area; and collecting, by the first-level streaming media management server, the second-level streaming media information corresponding to each media access service area, to obtain the first-level streaming media information, where the first-level streaming media information includes the total number of streaming media served by the media access service areas and the number of connected objects to each streaming media.

The first-level streaming media management server is a server that manages each the streaming media. For example, a first-level streaming media management server K manages the streaming media identifier Nos. 1 and No. 10. For each streaming media, the clients who enter the streaming media may come from different media access service areas or the same media access service area. The first-level streaming media information includes the total number of streaming media served by the media access service areas and the number of connected objects to each media access service area. An object can be understood as a user who logs on to the client. For example, in a live broadcast scene, the object can be a user who logs on to a live broadcast application. The connected object refers to a user connected to the media access service area, a user connected to the target access machine or a user connected to the streaming media. Therefore, the number of connected objects to the media access service area refers to the number of users connected to the media access service area. The media access resources of the first-level streaming media management server include the CPU information and internal memory information of the first-level streaming media management server. The media access resources of the second-level streaming media management server include the CPU information and internal memory information of the second-level streaming media management server. The second-level streaming media management server is a server that manages the streaming media in the media access service area. Specifically, the second-level streaming media management server is configured to collect the number of connected objects and the number of connected streaming media in the media access service area to which the second-level streaming media management server belongs, and the media access resources of the second-level streaming media management server in the corresponding media access service area.

Specifically, for each media access service area, second-level streaming media management information in a corresponding media access service area is determined by the second-level streaming media management server in the corresponding media access service area and sent to the first-level streaming media management server. The second-level streaming media information corresponding to each media access service area is connected by the first-level streaming media management server to obtain the first-level streaming media information. The second-level streaming media management information also includes the media access resources of the first-level streaming media management server and the media access resources of the second-level streaming media management server.

The first-level streaming media information can be periodically reported to the first-level load management server by the first-level streaming media management server and then periodically reported to the scheduling server by the first-level load management server; periodically queried and then pushed to the first load management server by the first-level streaming media management server, periodically queried and the pushed to the scheduling server by the first-level load management server; or actively pushed by the first-level streaming media management server to the first-level load management server, and then actively pushed by the first-level load management server to the scheduling server, which is not particularly limited. The second-level streaming media information can be periodically reported to the first-level streaming media management server by the second-level streaming media management server; periodically queried and then pushed to the first-level streaming media management server by the second-level streaming media management server; or actively pushed to the first-level streaming media management server by the second-level streaming media management server, which is not particularly limited. At least one first-level streaming media management server is provided in each cluster. Given one first-level streaming media management server in the cluster, the steaming media range of the first-level streaming media management server includes all streaming media in the cluster. Therefore, the above embodiment provides a process of determining the first-level streaming media information in the presence of one first-level streaming media management server.

In this embodiment, the second-level streaming media information pushed by the second-level streaming media management server is received by the first-level streaming media management server. The second-level streaming media information corresponding to each media access service area is collected by the first-level streaming media management server, to obtain the first-level streaming media information. That is, the streaming media information corresponding to each level is obtained by two-level streaming media query, so as to quickly and accurately obtain the first-level streaming media information, and improve the efficiency and accuracy of streaming media query.

In some embodiments, the method further includes: receiving the first-level streaming media information pushed by the first-level load management server, where the first-level streaming media information is queried by the first-level load management server from the first-level streaming media management server.

Specifically, the first-level streaming media information collected in advance is sent by the first-level load management server to the scheduling server.

For example, as shown in FIG. 5, one first-level streaming media management server is provided in the cluster to manage all the streaming media in the cluster, and two media access service areas are provided, which are a media access service area 1 and a media access service area 2 respectively. The first-level streaming media management server periodically queries the second-level streaming media management server in the media access service area 1, to obtain second-level streaming media information corresponding to the media access service area 1. Also, the first-level streaming media management server periodically queries the second-level streaming media management server in the media access service area 2, to obtain second-level streaming media information corresponding to the media access service area 2. The first-level streaming media management server obtains the first-level streaming media information according to the second-level streaming media information of each media access service area. The first-level streaming media management server sends the first-level streaming media information to the scheduling server. The two-level load management mode as shown in FIG. 5 can ensure that more clusters can be managed by one single cluster, so as to further improve the number of online objects supported by a single large room or the whole system at the same time. For example, if 200 media access service areas are managed, 200 media access machines are provided in each media access service area, and one media access machine can run 1000 users according to 1 Mbps traffic per user, so 200×200×1000=40000000 online objects can be supported at the same time. By simply adjusting the interval between load query and push, the number of media access service areas and machines managed by the whole cluster can be further improved.

In addition, the first-level streaming media management server will periodically query the load information of the media access machines in each media access service area, and save the load information of each media access machine, so that a migration operation can be performed when the first-level streaming media management server is shut down. The migration operation will be described later.

By receiving the first-level streaming media information pushed by the first-level load management server, the first-level streaming media information can be obtained directly and quickly, without querying the load information of all streaming media one by one. This greatly facilitates the obtaining of the first-level streaming media information, thus improving the speed and efficiency of obtaining the first-level streaming media information.

In this embodiment, the first-level streaming media management server receives the second-level streaming media information corresponding to each media access service area, and determines the first-level streaming media information. In this way, the streaming media information corresponding to each level can be obtained in time by two-level load query, so that the first-level streaming media information can be accurately and accurately determined.

In some embodiments, when at least two first-level streaming media management servers are provided, for each first-level streaming media management server, an area streaming media query request is periodically sent, by the corresponding first-level streaming media management server, to the second-level streaming media management server in each media access service area. The area streaming media query request carries the streaming media range corresponding to the corresponding first-level streaming media management server. For each media access service area, the second-level streaming media management server in the corresponding media access service area determines, in response to the area streaming media query request carrying the streaming media range corresponding to the corresponding first-level streaming media management server, second-level streaming media management information in the corresponding media access service area and falling within the streaming media range of the corresponding first-level streaming media management server. For each first-level streaming media management server, the corresponding first-level streaming media management server collects the second-level streaming media information corresponding to each media access service area that falls within the streaming media range of the corresponding first-level streaming media management server, to obtain first-level streaming media information corresponding to the corresponding first-level streaming media management server.

In case that at least two first-level streaming media management servers are provided in the cluster, each first-level streaming media management server corresponds to a streaming media range. For example, a first-level streaming media management server P corresponds to a streaming media range from streaming media identifier No. 1 to streaming media identifier No. 100. That is, the first-level streaming media management server P is responsible for the streaming media with the streaming media identifier No. 1 to No. 100.

In this embodiment, when at least two first-level streaming media management servers are provided, by determining the streaming media range of each first-level streaming media management server, the second-level streaming media management information belonging to the streaming media range of the first-level streaming media management server can be determined from the corresponding media access service area. Therefore, the first-level streaming media information belonging to the streaming media range of the first-level streaming media management server can be accurately determined, and the accuracy and precision of the load query corresponding to the streaming media are further ensured.

In some embodiments, the allocation request also carries a streaming media identifier for identifying a target streaming media. The method further includes: confirming that the client is connected to the target streaming media if the target media access machine verifies, according to the streaming media identifier, that the target media access machine, the second-level streaming media management server in the target media access service area where the target media access machine resides, and the first-level streaming media management server corresponding to the second-level streaming media management server are all connected to the target streaming media.

Specifically, after the client determines the target media access machine corresponding to the allocation request, the target media access machine obtains a target streaming media access request. The target streaming media access request is sent from the client, and the target streaming media access request carries a streaming media identifier identifying a target streaming media. The target media access machine verifies, according to the streaming media identifier, whether the target media access machine, the second-level streaming media management server in the target media access service area where the target media access machine resides, and the first-level streaming media management server corresponding to the second-level streaming media management server are all connected to the target streaming media. After verifying that the target media access machine, the second-level streaming media management server in the target media access service area where the target media access machine resides, and the first-level streaming media management server corresponding to the second-level streaming media management server are all connected to the target streaming media, it is determined that the client is connected to the target streaming media.

If the target media access machine verifies that the target media access machine, the second-level streaming media management server in the target media access service area where the target media access machine resides, and the first-level streaming media management server corresponding to the second-level streaming media management server are all connected to the target streaming media, it means that the target streaming media exists, that is, other clients have been connected to the target streaming media. Then, the second-level streaming media management server in the target media access service area where the target media access machine resides and the first-level streaming media management server corresponding to the second-level streaming media management server store the streaming media identifier by default. If the target media access machine verifies that at least one of the target media access machine, the second-level streaming media management server in the target media access service area where the target media access machine resides, and the first-level streaming media management server corresponding to the second-level streaming media management server is not connected to the target streaming media, it is not sure whether the target streaming media exists. The target streaming media may exist, but the target media access machine is not connected to the target streaming media, and the media access machines of other clients are connected to the target streaming media.

For example, after the client determines the target media access machine corresponding to the allocation request, the target media access machine receives the target streaming media access request sent from the client, and obtains the streaming media identifier for identifying the target streaming media from the target streaming media access request. When the target media access machine verifies, according to the streaming media identifier, that the target media access machine stores the streaming media identifier, it is directly determined that the target media access machine, the second-level streaming media management server in the target media access service area where the target media access machine resides, and the first-level streaming media management server corresponding to the second-level streaming media management server are all connected to the target streaming media, and the client is confirmed to be connected to the target streaming media. When the target media access machine verifies that the target media access machine does not store the streaming media identifier of the target streaming media, it is determined that the target media access machine is not connected to the target streaming media.

In this embodiment, when the target media access machine verifies, according to the streaming media identifier, that the target media access machine is connected to the target streaming media, it can be directly confirmed that the client is connected to the target streaming media. That is, it can be directly determined that the target streaming media exists, without re-establishing the target streaming media. That is, the process of confirming whether the client is connected to the target streaming media is simplified.

In some embodiments, the method further includes: saving, by the target media access machine, the streaming media identifier for connection to the target streaming media, when the target media access machine verifies, according to the streaming media identifier, that the target media access machine is not connected to the target streaming media, and querying, according to the streaming media identifier, whether the second-level streaming media management server in the target media access service area where the target media access machine resides is connected to the target streaming media; and confirming that the client is connected to the target streaming media if the second-level streaming media management server is connected to the target streaming media.

Specifically, when the target media access machine verifies, according to the streaming media identifier, that the target media access machine is not connected to the target streaming media, the target media access machine saves the streaming media identifier for connection to the target streaming media. The target media access machine saving the streaming media identifier performs consistent hash processing according to the streaming media identifier, to determine the target address of the second-level streaming media management server in the target media access service area where the target media access machine resides, and sends the target streaming media access request to the second-level streaming media management server of the target address. The second-level streaming media management server queries whether the second-level streaming media management server stores the streaming media identifier of the target streaming media. If the second-level streaming media management server queries that the second-level streaming media management server stores the streaming media identifier of the target streaming media, the client is confirmed to be connected to the target streaming media.

If the second-level streaming media management server stores the streaming media identifier of the target streaming media, it is sure that the target streaming media exists. If the second-level streaming media management server does not store the streaming media identifier of the target streaming media, it is not sure whether the target streaming media exists. The target streaming media may exist, that is, the target streaming media is not connected to the second-level streaming media management server of the target address, but to a second-level streaming media management server of another address in the target media access service area.

The consistent hash algorithm is a modulo operation of 2³², in which the whole hash value space is formed into a virtual ring, that is, a hash ring. The space of hash ring is organized clockwise, the point at the right top of the ring represents 0, the first point to the right of 0 represents 1, and so on, until the last point represents 2³²−1.

For example, it is assumed that the target media access service area where the target media access machine resides is an area A. The area A is located in a region a. There are two second-level streaming media management servers in the area A, for example, a second-level streaming media management server M and a second-level streaming media management server N. The streaming media identifier of the target streaming media is X. When the target media access machine verifies, according to the streaming media identifier X, that the target media access machine is not connected to the target streaming media, the target media access machine saves the streaming media identifier X for connection to the target streaming media, and the target media access machine performs consistent hash operation according to respective addresses of the second-level streaming media management server M and the second-level streaming media management server N, to map each address to the hash ring respectively. The target media access machine determines an initial position of the streaming media identifier on the hash ring, and the address of a first second-level streaming media management server met by moving clockwise along the hash ring from this initial position is taken as a target address. For example, the target address is the address of the second-level streaming media management server M. The target media access machine sends the target streaming media access request to the second-level streaming media management server M according to the target address. The second-level streaming media management server M queries whether the internal memory of the second-level streaming media management server M stores the streaming media identifier X of the target streaming media. If the streaming media identifier X exists in the internal memory of the second-level streaming media management server M, the client is confirmed to be connected to the target streaming media.

FIG. 6 schematically shows time consumption for first-frame audio/video decoding after the target media access machine is allocated for the client, the target media access machine is connected to the target streaming media, and it is sure that the second-level streaming media management server stores the streaming media identifier of the target streaming media. The first frame refers to a first video image in a video stream collected by the user. From Nov. 7, 2021 to Nov. 25, 2021, the time consumption for first-frame audio/video decoding decreases from 1050 milliseconds to 858.63 milliseconds, that is, the time consumption is reduced by 200 milliseconds, and about 20%. That is, whether the client is connected to the target streaming media is determined by multi-level convergence, which greatly reduces the time for first-frame audio/video decoding.

In this embodiment, the target media access machine saves the streaming media identifier for connection to the target streaming media, when the target media access machine verifies, according to the streaming media identifier, that the target media access machine is not connected to the target streaming media, and queries, according to the streaming media identifier, whether the second-level streaming media management server in the target media access service area where the target media access machine resides is connected to the target streaming media. The client is directly confirmed to be connected to the target streaming media if the second-level streaming media management server is connected to the target streaming media. That is, it can be directly determined that the target streaming media exists and there is no need to re-establish the target streaming media.

In some embodiments, the method further includes: saving, by the second-level streaming media management server, the streaming media identifier for connection to the target streaming media, if the second-level streaming media management server is not connected to the target streaming media, and querying, according to the streaming media identifier, whether the corresponding first-level streaming media management server is connected to the target streaming media; confirming that the client is connected to the target streaming media if the first-level streaming media management server is connected to the target streaming media; and allocating a first-level streaming media management server for the target streaming media if the first-level streaming media management server is not connected to the target streaming media, saving, by the allocated first-level streaming media management server, the streaming media identifier, and confirming that the client is connected to the target streaming media.

Specifically, if the second-level streaming media management server verifies that the second-level streaming media management server is not connected to the target streaming media, the second-level streaming media management server saves the streaming media identifier for connection to the target streaming media, and the second-level streaming media management server saving the streaming media identifier sends the target streaming media access request to the scheduling server. The scheduling server determines a corresponding first-level streaming media management server matching the streaming media identifier from a public remote dictionary server. If the corresponding first-level streaming media management server stores the streaming media identifier, that is, the corresponding first-level streaming media management server is connected to the target streaming media, the scheduling server confirms that the client is connected to the target streaming media. If the corresponding first-level streaming media management server does not store the streaming media identifier, that is, the corresponding first-level streaming media management server is not connected to the target streaming media, the scheduling server allocates a first-level streaming media management server for the target streaming media according to the first-level streaming media information from the first-level streaming media management server corresponding to the target media access service area, to obtain an allocated first-level streaming media management server. The scheduling server sends an address of the allocated first-level streaming media management server to the second-level streaming media management server saving the streaming media identifier, the allocated first-level streaming media management server saves the streaming media identifier, and the client is confirmed to be connected to the target streaming media.

The public remote dictionary server stores the first-level streaming media management server respectively corresponding to each streaming media identifier in advance, which can be understood as the public remote dictionary server storing allocated first-level streaming media management servers.

For example, if the second-level streaming media management server verifies that the second-level streaming media management server is not connected to the target streaming media, the second-level streaming media management server saves the streaming media identifier for connection the target streaming media, and the second-level streaming media management server saving the streaming media identifier sends the target streaming media access request to the scheduling server. The scheduling server determines a corresponding first-level streaming media management server matching the streaming media identifier from a public remote dictionary server. If the scheduling server verifies that the corresponding first-level streaming media management server is not shut down, and the first-level streaming media management server stores the streaming media identifier, the scheduling server confirms that the client is connected to the target streaming media. If the corresponding first-level streaming media management server does not store the streaming media identifier, or the corresponding first-level streaming media management server is shut down, the scheduling server determines an address of an allocated first-level streaming media management server by weighted randomization, according to the first-level streaming media information from the first-level streaming media management server corresponding to the target media access service area. The scheduling server sends the address of the allocated first-level streaming media management server to the second-level streaming media management server saving the streaming media identifier, the allocated first-level streaming media management server saves the streaming media identifier, and the client is confirmed to be connected to the target streaming media.

In this embodiment, if the second-level streaming media management server is not connected to the target streaming media, an upper level above the second-level streaming media management server is further queried, that is, whether the first-level streaming media management server is connected to the target streaming media is queried. If it is queried that the first-level streaming media management server is connected to the target streaming media, the target streaming media is directly determined to exist, that is, the client is connected to the target streaming media. A first-level streaming media management server is allocated for the target streaming media if the first-level streaming media management server is not connected to the target streaming media, and the allocated first-level streaming media management server saves the streaming media identifier, so that the client can be connected to the target streaming media. In this way, it can be ensured that there is a corresponding server in the target media access service area to manage the client, so that the client can accurately and efficiently obtain the target media stream of the target streaming media subsequently.

In some embodiments, the client is a client uplinking data, and after the client is connected to the target streaming media, the method further includes: generating a notification signaling about a streamer by the target media access machine, where the notification signaling carries the streaming media identifier of the target streaming media; sending, by the target media access machine, the notification signaling to the first-level streaming media management server corresponding to the second-level streaming media management server, via the second-level streaming media management server in the target media access service area; sending, by the first-level streaming media management server, the notification signaling to the second-level streaming media management server storing the streaming media identifier in each media access service area, and sending, by each second-level streaming media management server, the notification signaling to the media access machine storing the streaming media identifier in the corresponding media access service area; and sending the notification signaling to the client connected to the target streaming media by the media access machine.

The client uplinking data is a client that uploads media data, and is also referred to as an “uplinking client”. In a live broadcast scene, the client uplinking data is a client of a streamer. The notification signaling can be a signaling to transmit a streamer address of the streamer when the streamer is online, or a signaling to transmit a switched streamer address when a viewer is switched to a streamer. In an embodiment, once the client of each streamer is connected to the target streaming media, at this time, the notification signaling is a signaling for transmitting the address of the online streamer. The notification signaling carries the address of the target media access machine connected to the client of the streamer, and will be sent to the media access machine to which the client of each user of the same streaming media is connected by the notification signaling. In an embodiment, when the client is switched from a client not uplinking data to a client uplinking data, the notification signaling is a signaling that transmits the address of the switched streamer. The notification signaling carries the address of the target media access machine to which the client switched to uplink data is connected, and the notification signaling is sent to the media access machine to which the client of each user of the same streaming media is connected by the notification signaling.

Specifically, after a client uplinking data is connected to the target streaming media, the target media access machine generates a notification signaling about a streamer, where the notification signaling carries the streaming media identifier of the target streaming media. The target media access machine sends the notification signaling to the second-level streaming media management server in the target media access service area. The second-level streaming media management server sends the notification signaling to the first-level streaming media management server corresponding to the second-level streaming media management server. The first-level streaming media management server sends the notification signaling to the second-level streaming media management server storing the streaming media identifier in each media access service area. The second-level streaming media management server in each media access service area respectively sends the notification signaling to the media access machine storing the streaming media identifier in the media access service area. Each media access machine sends the notification signaling to the client entering the target streaming media.

The notification signaling is used to inform all media access machines storing the same streaming media identifier of the address of the media access machine to which the client has uplink and downlink permission, and also to inform all users in the streaming media of the information that the streamer having uplink and downlink permission enters the streaming media.

After the client uplinking data quits the connected target streaming media, the target media access machine generates a notification signaling of the streamer quit, where the notification signaling carries the streaming media identifier of the target streaming media. The target media access machine sends the notification signaling of the streamer quit to the second-level streaming media management server in the target media access service area. The second-level streaming media management server sends the notification signaling of the streamer quit to the first-level streaming media management server corresponding to second-level streaming media management server. The first-level streaming media management server sends the notification signaling of the streamer quit to the second-level streaming media management server storing the streaming media identifier in each media access service area. The second-level streaming media management server in each media access service area respectively sends the notification signaling of the streamer quit to the media access machine storing the streaming media identifier in the corresponding media access service area. Each media access machine respectively sends the notification signaling of the streamer quitting to the client of the target streaming media, so as to inform all users in the target streaming media that the streamer has quit in time.

The notification signaling is sequentially distributed, by three-level convergence, to the first-level streaming media management server, the second-level streaming media management server, each media access machine located in the same media access service area that the second-level streaming media management server resides, and all clients with the same streaming media identifier as the clients uplinking data.

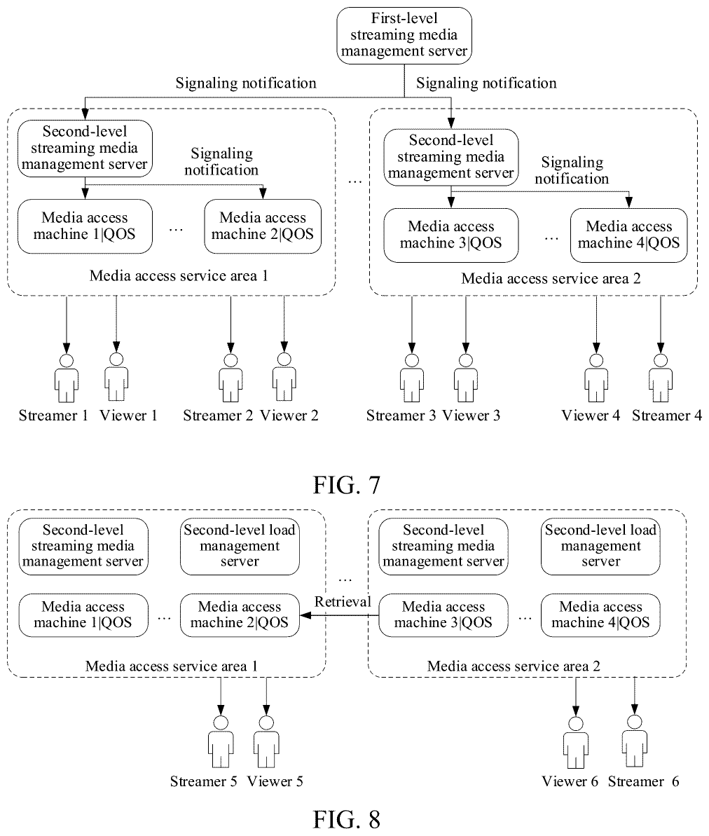

For example, as shown in FIG. 7, one first-level streaming media management server, a media access service area 1 and a media access service area 2 are provided. A client of a streamer 1 and a client of a viewer 1 are connected to the media access machine 1 in the media access service area 1. A client of a streamer 2 and a client of a viewer 2 are connected to the media access machine 2 in the media access service area 1. A client of a streamer 3 and a client of a viewer 3 are connected to the media access machine 3 in the media access service area 2. A client of a streamer 4 and a client of a viewer 4 are connected to the media access machine 4 in the media access service area 2. Both the media access service area 1 and the media access service area 2 store the streaming media identifier of the target streaming media. Each media access machine is provided with a QoS module. After a client H uplinking data is connected to the target streaming media, the target media access machine to which the client H uplinking data is connected generates a notification signaling about the streamer, and sends the notification signaling to the second-level streaming media management server in the target media access service area, and the second-level streaming media management server sends the notification signaling to the first-level streaming media management server corresponding to the second-level streaming media management server. The first-level streaming media management server sends the notification signaling to the second-level streaming media management server storing the streaming media identifier in the media access service area 1 and the second-level streaming media management server in the media access service area 2. The second-level streaming media management server in the media access service area 1 sends the notification signaling respectively to the media access machine 1 and the media access machine 2, and the second-level streaming media management server in the media access service area 2 sends the notification signaling respectively to the media access machine 3 and the media access machine 4. Each media access machine sends the notification signaling to corresponding clients respectively.

In this embodiment, after determining that the client uplinking data is connected to the target streaming media, the target media access machine transmits the notification signaling from the second-level streaming media management server in the target media access service area to the first-level streaming media management server. In this way, the notification signaling is transmitted to the upper two levels to ensure that the notification signaling can reach the first-level streaming media management server. The first-level streaming media management server distributes the notification signaling sequentially downward to multiple levels, which greatly reduces the signaling distribution pressure of streaming media with large capacity, thus ensuring the efficiency of signaling transmission, and further ensuring that all users entering the target streaming media can obtain the media data sent by the client uplinking data in real time.

In some embodiments, after the first-level streaming media management server verifies that a client not uplinking data is connected to the target streaming media, the first-level streaming media management server sends a notification signaling carrying streamer list information in the streaming media identifier to the second-level streaming media management server in the media access service area where the client not uplinking data resides, and the second-level streaming media management server sends the notification signaling carrying the streamer list information to the target media access machine storing the streaming media identifier in the corresponding media access service area. The target media access machine sends the notification signaling carrying the streamer list information to the client not uplinking data, such that the client not uplinking data can determine an audio/video user list of interest according to the streamer list information. At least one streamer identifier in the audio/video user list a streamer identifier that the client not uplinking data has interest in.

In this embodiment, once the client not uplinking data is connected to the target streaming media, the first-level streaming media management server distributes the notification signaling carrying the streamer list information sequentially downward to multiple levels, so that the client not uplinking data can obtain each streamer identifier in the target streaming media in time, which facilitates the user of the client not uplinking data to get to know the streamers existing in the target streaming media in time and in real time, thus improving the convenience during use.

In some embodiments, the client is a client downlinking data, and after the client downlinking data is connected to the target streaming media, the method further includes: sending, by the client downlinking data, a switch request to the target media access machine, where the switch request is a request to switch the client downlinking data to a client uplinking data; converting, by the target media access machine, the client downlinking data into a client uplinking data; generating, by the target media access machine, a notification signaling of newly adding a streamer, where the notification signaling carries the streaming media identifier of the target streaming media; sending, by the target media access machine, the notification signaling to the first-level streaming media management server corresponding to the second-level streaming media management server, via the second-level streaming media management server in the target media access service area; sending, by the first-level streaming media management server, the notification signaling to the second-level streaming media management server storing the streaming media identifier in each media access service area, and sending, by each second-level streaming media management server, the notification signaling to the media access machine storing the streaming media identifier in the corresponding media access service area; and sending the notification signaling to the client connected to the target streaming media by the media access machine.

The client downlinking data mentioned above refers to a client that receives media data, and is also referred to as a “downlinking client.” For example, in a live broadcast scene, the client downlinking data refers to a client of a viewer.

In this embodiment, when the client downlinking data is switched to a client uplinking data, it is directly switched to a client uplinking data by the target media access machine to which the client downlinking data is connected, without a process of the client downlinking data re-entering the room to the interface machine. This enables the smooth connection of the user downlinking data to the microphone and greatly improves the conversion efficiency of the client.

In some embodiments, the client is a client downlinking data, and after the client is connected to the target streaming media, the method further includes: determining, by the target media access machine, a retrieving machine in the target media access service area that is connected to the target streaming media, so that the retrieving machine pulls a target media stream from a source media access machine according to an address of the source media access machine to which a streamer client of the target streaming media is connected; and distributing, by the retrieving machine, the target media stream to the media access machine in the target media access service area that is connected to the target streaming media.

The retrieving machine can be a media access machine in the media access service area, and the retrieving machine is a machine for pulling the target media stream. The target media stream can be understood as the streamer's media data, such as audio/video data.

Specifically, the target media access machine performs consistent hash calculation on the streamer identifier to determine the retrieving machine for pulling the target media stream. The retrieving machine pulls the target media stream from the source media access machine according to the address of the source media access machine to which the streamer client of the target streaming media is connected. After the retrieving machine pulls the target media stream, the retrieving machine distributes the target media stream to the media access machine in the target media access service area that is connected to the target streaming media.

The media access service area where the source media access machine resides may be the target media access service area or an area other than the target media access service area. When the media access service area where the source media access machine resides is an area other than the target media access service area, the retrieving machine pulls the target media stream across the media access service area.

For example, as shown in FIG. 8, both a media access service area 1 and a media access service area 2 have a second-level streaming media management server, a second-level load management server, and a media access machine deployed with a QoS module. A client of a viewer 6 and a client of a streamer 6 are connected to the media access machine 4 in the media access service area 2. A client of a viewer 5 and a client of a streamer 5 are connected to the media access machine 2 in the media access service area 1. The client of the viewer 6 in the media access service area 2 sends an audio/video obtaining request to the media access machine 4. The audio/video obtaining request carries a streamer identifier of the streamer 5. The media access machine 4 performs consistent hash calculation on the streamer identifier, and determines that the retrieving machine for pulling the target media stream is the media access machine 3 in the media access area 2, and the media access machine 4 sends the address of the media access machine 3 to which the client of the streamer 5 is connected to the media access machine 3. The target media stream is pulled from the media access machine 2 by the media access machine 3, to realize a retrieval operation of the media access machine 3 on the media access machine 2. After the retrieving machine pulls the target media stream, the retrieving machine distributes the target media stream to the media access machine 4 in the media access service area 2 that is connected to the target streaming media, to realize a retrieval operation of the media access machine 4 on the media access machine 3, and the client of the viewer 6 obtains the target media stream from the media access machine 4 of the target streaming media.

In this embodiment, when the client is a client downlinking data, the target media access machine determines a retrieving machine in the target media access service area that is connected to the target streaming media. The target media stream is pulled by one retrieving machine according to demand, so that the default forwarding of the target media stream by all media access machines in the target streaming media is avoided, and the traffic crossing between areas is greatly reduced. At the same time, the process of obtaining the target media stream is also simplified, thus improving the efficiency of obtaining the target media stream.

In some embodiments, the client is a client downlinking data. After the client is connected to the target streaming media, the client downlinking data determines an audio/video user list of interest according to the streamer list information. The audio/video user list includes at least one streamer identifier, in which each streamer identifier is a streamer identifier that the client not uplinking data (that is, the client downlinking data) has interest in. After the first-level streaming media management server obtains the audio/video list, the first-level streaming media management server determines an address of a preprocessing media access machine of the client where the interested streamer identifier resides. The first-level streaming media management server sends a pushed signaling notification carrying the address of the target media access machine to the second-level streaming media management server in the media access service area determined by each preprocessing media access machine, and the second-level streaming media management server sends the pushed signaling notification carrying the address of the target media access machine respectively to each preprocessing media access machine, so that each preprocessing media access machine pushes the target media stream corresponding to each preprocessing media access machine according to demand.

The operation of pushing the target media stream by each preprocessing media access machine includes: determining, by the target media access machine, a retrieving machine in the target media access service area that is connected to the target streaming media, so that the retrieving machine pulls a target media stream corresponding to the corresponding preprocessing media access machine from the preprocessing media access machine according to the address of the corresponding preprocessing media access machine; and distributing, by the retrieving machine, the target media stream corresponding to the corresponding preprocessing media access machine to the media access machine in the target media access service area that is connected to the target streaming media.

In this embodiment, after determining the audio/video user list determined by the client not uplinking data, the first-level streaming media management server pushes the address of the target media access machine respectively to each preprocessing media access machine corresponding to the audio/video user list, so that the preprocessing media access machine can accurately determine the address of the target media access machine having target media stream requirements. In this way, the pushing of the target media stream required by the client downlinking data is realized according to demand.

In some embodiments, the method further includes: receiving a streaming media management allocation request sent from the second-level streaming media management server in the target media access service area; and selecting a first-level streaming media management server that is allocated for the second-level streaming media management server from the first-level streaming media management servers that are not shut down according to the load status indicated by the first-level streaming media information from each first-level streaming media management server, in response to the streaming media management allocation request, where the streaming media management allocation request is a request sent when the second-level streaming media management server in the target media access service area verifies that the first-level streaming media management server is shut down; and sending an address of the allocated first-level streaming media management server to the second-level streaming media management server and each media access machine corresponding to the target media access service area, such that the second-level streaming media management server and each media access machine corresponding to the target media access service area migrate the number of streaming media and the number of connected objects served by the target media access service area to the first-level streaming media management server according to the address.

Specifically, a streaming media management allocation request is generated when the second-level streaming media management server in the target media access service area verifies that the first-level streaming media management server shut down, and the second-level streaming media management server sends the streaming media management allocation request to the scheduling server. The scheduling server determines, in response to the streaming media management allocation request, a corresponding first-level streaming media management server matching the streaming media identifier from a public remote dictionary server. If the corresponding first-level streaming media management server matching the streaming media identifier is a shut-down first-level streaming media management server, the scheduling server selects a first-level streaming media management server that is allocated for the second-level streaming media management server from the first-level streaming media management servers that are not shut down by weighted randomization according to the load status indicated by the first-level streaming media information from the first-level streaming media management server. The scheduling server sends an address of the allocated first-level streaming media management server to the second-level streaming media management server and each media access machine in the target media access service area, such that the second-level streaming media management server and each media access machine in the target media access service area migrate the number of streaming media and the number of connected objects served by the target media access service area to the first-level streaming media management server according to the address.

The first-level streaming media management server corresponds to the second-level streaming media management server in each media access service area. Each second-level streaming media management server respectively confirms whether the first-level streaming media management server is shut down. After one second-level streaming media management server confirms that the first-level streaming media management server is shut down, the migration to the subsequently allocated first-level streaming media management server only involves the migration of the number of steaming media and the number of connected objects corresponding to the one second-level streaming media management server confirming that the first-level streaming media management server is shut down and the media access machines in the media access service area where the second-level streaming media management server resides.

For example, the first-level streaming media management server corresponds to a media access service area 1 and a media access service area 2. After the second-level streaming media management server in the media access service area 1 determines that the first-level streaming media management server is shut down and after an address of the allocated first-level streaming media management server 1 is determined, the number of steaming media and the number of connected objects corresponding to the second-level streaming media management server and the media access machines in the media access service area 1 are migrated to the allocated first-level streaming media management server 1. Correspondingly, after the second-level streaming media management server in the media access service area 2 determines that the first-level streaming media management server is shut down and after an address of the allocated first-level streaming media management server 2 is determined, the number of steaming media and the number of connected objects corresponding to the second-level streaming media management server and the media access machines in the media access service area 2 are migrated to the allocated first-level streaming media management server 2.

In this embodiment, once the second-level streaming media management server in the target media access service area verifies that the first-level streaming media management server is shut down, a first-level streaming media management server that is allocated for the second-level streaming media management server is accurately and directly selected from the first-level streaming media management servers that are not shut down according to the load status indicated by the first-level streaming media information from each first-level streaming media management server. In this way, the second-level streaming media management server and each media access machine in the target media access service area can accurately and automatically migrate the number of streaming media and the number of connected objects served by the target media access service area to the allocated first-level streaming media management server, without perception by the users, so as to improve the ability of automatic recovery ability.

The data transmission method of this application can realize the scheduling efficiency of the machine scheduling strategy. This method has many application scenarios.

For example, in a scene involving online meeting, clients from different regions can realize real-time online communication by connection to the same virtual meeting room. That is, each client needs to connect to a media access machine, so that audio and video can be received and sent through the media access machine. When the connection of a large number of clients is involved, the allocation of media access machines for the clients can be quickly and accurately realized through the data transmission method of this application. Specifically, an allocation request of a client for a media access machine is obtained. In response to the allocation request, a target media access service area to which the client is to be connected is determined from multiple media access service areas according to first-level load information of each of the media access service areas. A target media access machine to which the client is to be connected is determined from multiple media access machines corresponding to the target media access service area according to second-level load information of the target media access service area. The target media access machine is allocated for the client to transmit media data between the client and the target media access machine.

Of course, this application is not limited thereto. The data transmission method provided in this application can also be applied to other application scenarios. For example, in online classroom, online recruitment, online signing, communication, entertainment, dating and live broadcast scenes, when a large number of clients are connected, the data transmission method provided in this application can be used to improve the scheduling efficiency.

The above application scenarios are only schematic illustrations, and the application of the data transmission method provided in each embodiment of this application is not limited to the above scenarios.

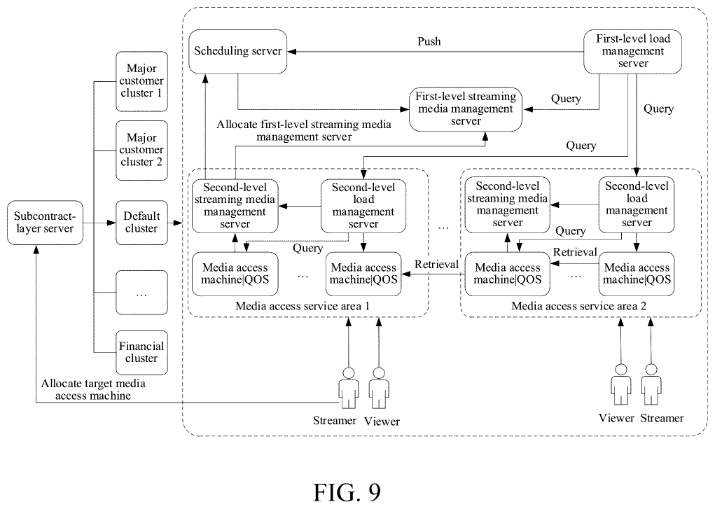

In a specific embodiment, a data transmission system architecture schematically shown in FIG. 9 is provided. Each cluster has only one corresponding scheduling server, configured to schedule machines in the cluster. At least one media access service area is provided in each cluster. Each media access service area includes at least one second-level streaming media management server, at least one second-level load management server and at least one media access machine. For each media access service area, the second-level load management server queries load information of the media access service area and determines second-level load information corresponding to the media access service area. The load information of the media access service area includes at least one of the CPU information and internal memory information of the media access machines and the second-level streaming media management server of the media access service area, and the number of streaming media and the number of objects connected to the media access machines. The first-level load management server queries each media access service area, and the second-level load management server of each media access service area reports respective second-level load information to the first-level load management server. The first-level load management server determines first-level load information according to the second-level load information corresponding to each media access service area, and pushes the first-level load information to the scheduling server. Each second-level streaming media management server will request the scheduling server to allocate a first-level streaming media management server. The second-level streaming media management server in each media access service area sends respective second-level streaming media information obtained to the allocated first-level streaming media management server. The first-level streaming media management server determines first-level streaming media information according to second-level streaming media information of each media access service area, and sends the first-level streaming media information to the first-level load management server. The first-level load management server pushes the first-level streaming media information to the scheduling server. After receiving an allocation request carrying a streaming media identifier to be connected by the client and a client identifier, the scheduling server determines, in response to the allocation request, a target media access service area to which the client is to be connected from multiple media access service areas according to the first-level load information of each of the multiple media access service areas obtained by the first-level load management server. The scheduling server determines a target media access machine to which the client is to be connected from multiple media access machines corresponding to the target media access service area according to the second-level load information of the target media access service area obtained by the second-level load management server. The scheduling server allocates the target media access machine for the client to transmit media data between the client and the target media access machine. The client may be a client uplinking data or a client downlinking data.

For example, two media access service areas are provided in FIG. 9, which are a media access service area 1 and a media access service area 2 respectively. Each media access service area includes a second-level streaming media management server, a second-level load management server, and a media access machine deployed with a QoS module. Each media access machine is connected to a client of a streamer and a client of a viewer. The servers involved in this system may be of different models, for example, a cloud server with the CPU being Intel® Xeon® Platinum 8255C CPU @ 2.50 GHz and the operating system being 3.10.107-1-tlinux2_kvm_guest-0052, which is not limited.

Specifically, a terminal generates an allocation request carrying a streaming media identifier to be connected by a client and a client identifier, in response to a user's trigger operation on the client. The terminal sends the allocation request to a subcontract-layer server, and the subcontract-layer server determines a target cluster from a major customer cluster 1, a major customer cluster 2, a default cluster and a financial cluster according to the streaming media identifier or the client identifier in the allocation request. The subcontract-layer server sends the allocation request carrying the streaming media identifier to be connected by the client and the client identifier to a scheduling server in the target cluster, and the scheduling server obtains the allocation request of the client for a media access machine. In response to the allocation request, a target media access service area to which the client is to be connected is determined from multiple media access service areas according to first-level load information corresponding to each of the media access service areas, which are obtained by division according to region, where the first-level load information is pushed by a first-level load management server. A target media access machine to which the client is to be connected is determined from the media access machines in the target media access service area according to the second-level load information of the target media access service area pushed by the second-level load management server in the target media access service area to the first-level load management server. The target media access machine is allocated for the client to transmit media data between the client and the target media access machine. The scheduling server receives the first-level load information pushed by the first-level load management server. The first-level load information is obtained through a process including: receiving, by the first-level load management server, the second-level load information pushed by the second-level load management server, where the second-level load information includes the number of connected objects and the number of connected streaming media served by a corresponding media access service area, and the media access resources corresponding to the corresponding media access service area; collecting, by the first-level load management server, the second-level load information corresponding to each media access service area, to obtain the first-level load information, where the first-level load information includes the number of connected objects and the number of connected streaming media served by each media access service area, and the media access resources corresponding to each media access service area; and receiving the first-level load information pushed by the first-level load management server. Also, the first-level load management server pushes the first-level streaming media information to the scheduling server. The first-level streaming media information is obtained through a process including: receiving, by the first-level streaming media management server, the second-level streaming media information pushed by the second-level streaming media management server, where the second-level streaming media information includes the number of streaming media and the number of connected objects served by a corresponding media access service area; and collecting, by the first-level streaming media management server, the second-level streaming media information corresponding to each media access service area, to obtain the first-level streaming media information, where the first-level streaming media information includes the total number of streaming media served by the media access service areas, which are obtained by division according to region, and the number of connected objects connected to each streaming media.

After determining the target media access machine to which the client is to be connected, the client is confirmed to be connected to the target streaming media when the target media access machine verifies, according to the streaming media identifier, that the target media access machine, the second-level streaming media management server in the target media access service area where the target media access machine resides, and the first-level streaming media management server corresponding to the second-level streaming media management server are all connected to the target streaming media. The target media access machine saves the streaming media identifier for connection to the target streaming media, when the target media access machine verifies, according to the streaming media identifier, that the target media access machine is not connected to the target streaming media, and queries, according to the streaming media identifier, whether the second-level streaming media management server in the target media access service area where the target media access machine resides is connected to the target streaming media. The client is confirmed to be connected to the target streaming media in case that the second-level streaming media management server is connected to the target streaming media. The second-level streaming media management server saves the streaming media identifier for connection to the target streaming media, in case that the second-level streaming media management server is not connected to the target streaming media, and queries, according to the streaming media identifier, whether the corresponding first-level streaming media management server is connected to the target streaming media. The client is confirmed to be connected to the target streaming media in case that the first-level streaming media management server is connected to the target streaming media. A first-level streaming media management server is allocated for the target streaming media in case that the first-level streaming media management server is not connected to the target streaming media, the allocated first-level streaming media management server saves the streaming media identifier, and the client is confirmed to be connected to the target streaming media.

After a client uplinking data is connected to the target streaming media, the target media access machine generates a notification signaling about a streamer, where the notification signaling carries the streaming media identifier of the target streaming media. The target media access machine sends the notification signaling to the first-level streaming media management server corresponding to the second-level streaming media management server, via the second-level streaming media management server in the target media access service area. The first-level streaming media management server sends the notification signaling to the second-level streaming media management server storing the streaming media identifier in each media access service area, and each second-level streaming media management server sends the notification signaling to the media access machine storing the streaming media identifier in the corresponding media access service area. The media access machine sends the notification signaling to the client connected to the target streaming media. After a client downlinking data is connected to the target streaming media, the target media access machine determines a retrieving machine in the target media access service area that is connected to the target streaming media, so that the retrieving machine can pull a target media stream from a source media access machine according to an address of the source media access machine to which a streamer client of the target streaming media is connected. The retrieving machine distributes the target media stream to the media access machine in the target media access service area that is connected to the target streaming media.

After the second-level streaming media management server in the target media access service area verifies that the first-level streaming media management server is shut down, a streaming media management allocation request sent from the second-level streaming media management server in the target media access service area is received; and in response to the streaming media management allocation request, a first-level streaming media management server that is allocated for the second-level streaming media management server is selected from the first-level streaming media management servers that are not shut down, according to the load status indicated by the first-level streaming media information from each first-level streaming media management server. An address of the allocated first-level streaming media management server is sent to the second-level streaming media management server and each media access machine in the target media access service area, such that the second-level streaming media management server and each media access machine in the target media access service area migrate the number of streaming media and the number of connected objects served by the target media access service area to the first-level streaming media management server according to the address.

In this embodiment, in response to the allocation request, a target media access service area corresponding to the client is positioned from the first-level load information corresponding to each of the media access service areas, which are obtained by division according to region, where the first-level load information is pushed by the first-level load management server. According to the second-level load information of the target media access service area pushed by the second-level load management server in the target media access service area to the first-level load management server, a target media access machine to which the client is to be connected is rapidly and accurately determined in the target media access service area, so as to transmit data between the client and the target media access machine. In this way, according to the media access service areas, which are obtained by division according to region, the load management of different machines at different levels is realized, and the aggregation scheduling at a single machine level can be transformed into the aggregation scheduling of media access service areas with a higher processing power, thus avoiding the excessive aggregation of single machines, improving the high concurrency and system performance, ensuring that the whole scheduling process of the media access machines can be implemented in the area where the client resides, greatly simplifying the whole scheduling process, and thus improving the scheduling efficiency.

In some embodiments, a data transmission system is provided, which includes a client, a scheduling server, a first-level load management server, and a second-level load management server located in each media access service area divided according to the geographical region.

The second-level load management server located in each media access service area is configured to push second-level load information of a corresponding media access service area to the first-level load management server.

The first-level load management server is configured to push first-level load information corresponding to each media access service area to the scheduling server.

The scheduling server is configured to obtain an allocation request of the client for a media access machine; determine, in response to the allocation request, a target media access service area to which the client is to be connected from multiple media access service areas according to the first-level load information of each of the media access service areas; determine a target media access machine to which the client is to be connected from multiple media access machines corresponding to the target media access service area according to the second-level load information of the target media access service area; and allocate the target media access machine for the client to transmit media data between the client and the target media access machine.

For the specific implementation of the above data transmission system, please refer to the embodiment of the data transmission method as described above. In the data transmission system, the target media access service area corresponding to the client is determined according to the first-level load information of multiple media access service areas, in response to the allocation request. According to second-level load information of the target media access service area, a target media access machine in the target media access service area to which the client is to be connected is quickly and accurately determined, so as to transmit media data between the client and the target media access machine. In this way, by performing load management according to the media access service area, the load management of the different machines at different levels is realized, and the aggregation scheduling at a single machine level can be transformed into the aggregation scheduling of media access service areas with a higher processing power, thus avoiding the excessive aggregation of single machines, improving the high concurrency and system performance, simplifying the whole scheduling process of the media access machine, and thus improving the scheduling efficiency.

Although the operations are displayed sequentially according to the instructions of the arrows in the flowcharts involved in the embodiments as described above, these operations are not necessarily performed sequentially according to the sequence instructed by the arrows. Unless otherwise explicitly specified in this application, the implementation of the operations is not strictly limited, and the operations may be performed in other sequences. Moreover, at least some of the operations in the flowchart involved in each embodiment as described above may include multiple operations or multiple stages. The operations or stages are not necessarily performed at the same moment but may be performed at different moments. The implementation of the operations or stages is not necessarily sequentially performed, but may be performed alternately with other operations or at least some of the operations or stages in other operations.

Based on the same inventive concept, an embodiment of this application further provides a data transmission apparatus for implementing the foregoing data transmission method. The problem-solving implementation provided by the apparatus is similar to the implementation recorded in the above method. Therefore, the specific definitions in one or more embodiments of the data transmission apparatus provided below can be made reference to the above definitions in the data transmission method, and will not be further described again.

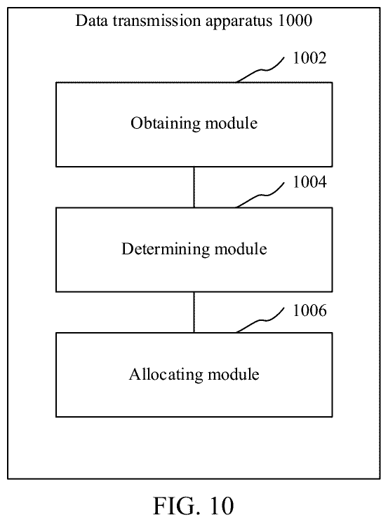

In some embodiments, as shown in FIG. 10, a data transmission apparatus is provided. The data transmission apparatus 1000 includes: an obtaining module 1002, a determining module 1004, and an allocating module 1006.

The obtaining module 1002 is configured to obtain an allocation request of a client for a media access machine.

The determining module 1004 is configured to determine, in response to the allocation request, a target media access service area to which the client is to be connected from multiple media access service areas according to first-level load information of each of the media access service areas.

The determining module 1004 is further configured to determine a target media access machine to which the client is to be connected from multiple media access machines corresponding to the target media access service area according to second-level load information of the target media access service area.

The allocating module 1006 is configured to allocate the target media access machine for the client to transmit media data between the client and the target media access machine.

In some embodiments, the data transmission apparatus further includes a first information obtaining module. The first information obtaining module is configured to receive, through a first-level load management server, the second-level load information pushed by a second-level load management server, where the second-level load information includes the number of connected objects and the number of connected streaming media served by a corresponding media access service area, and the media access resources corresponding to the corresponding media access service area; collect, through the first-level load management server, the second-level load information corresponding to each media access service area, to obtain the first-level load information, where the first-level load information includes the number of connected objects and the number of connected streaming media served by each media access service area, and the media access resources corresponding to each media access service area; and receive the first-level load information pushed by the first-level load management server.

In some embodiments, the data transmission apparatus further includes a second information obtaining module. The second information obtaining module is configured to receive, through a first-level streaming media management server, second-level streaming media information pushed by a second-level streaming media management server, where the second-level streaming media information includes the number of streaming media and the number of connected objects served by a corresponding media access service area; and collect, through the first-level streaming media management server, the second-level streaming media information corresponding to each media access service area, to obtain first-level streaming media information, where the first-level streaming media information includes the total number of streaming media served by the media access service areas and the number of connected objects to each streaming media.

In some embodiments, the second information obtaining module is further configured to receive the first-level streaming media information pushed by the first-level load management server, where the first-level streaming media information is queried by the first-level load management server from the first-level streaming media management server.

In some embodiments, the allocation request further carries a streaming media identifier for identifying a target streaming media. The apparatus further includes a confirming module. The confirming module is configured to confirm that the client is connected to the target streaming media when the target media access machine verifies, according to the streaming media identifier, that the target media access machine, the second-level streaming media management server in the target media access service area where the target media access machine resides, and the first-level streaming media management server corresponding to the second-level streaming media management server are all connected to the target streaming media.

In some embodiments, the confirming module is further configured to save, by the target media access machine, the streaming media identifier for connection to the target streaming media, when the target media access machine verifies, according to the streaming media identifier, that the target media access machine is not connected to the target streaming media, and query, according to the streaming media identifier, whether the second-level streaming media management server in the target media access service area where the target media access machine resides is connected to the target streaming media; and confirm that the client is connected to the target streaming media in case that the second-level streaming media management server is connected to the target streaming media.

In some embodiments, the confirming module is further configured to save, by the second-level streaming media management server, the streaming media identifier for connection to the target streaming media, in case that the second-level streaming media management server is not connected to the target streaming media, and query according to the streaming media identifier, whether the corresponding first-level streaming media management server is connected to the target streaming media; confirm that the client is connected to the target streaming media in case that the first-level streaming media management server is connected to the target streaming media; and allocate a first-level streaming media management server for the target streaming media in case that the first-level streaming media management server is not connected to the target streaming media, save, by the allocated first-level streaming media management server, the streaming media identifier, and confirm that the client is connected to the target streaming media.

In some embodiments, the client is a client uplinking data. The data transmission apparatus further includes a signaling notification module. After the client is connected to the target streaming media, the signaling notification module is configured to generate, by the target media access machine, a notification signaling about the streamer, where the notification signaling carries the streaming media identifier of the target streaming media; send, by the target media access machine, the notification signaling to the first-level streaming media management server corresponding to the second-level streaming media management server, via the second-level streaming media management server in the target media access service area; send, by the first-level streaming media management server, the notification signaling to the second-level streaming media management server storing the streaming media identifier in each media access service area, and send, by each second-level streaming media management server, the notification signaling to media access machine storing the streaming media identifier in the corresponding media access service area; and send the notification signaling to the client connected to the target streaming media by the media access machine.

In some embodiments, the client is a client downlinking data. The data transmission apparatus further includes a distributing module. After the client is connected to the target streaming media, the distributing module is configured to determine, by the target media access machine, a retrieving machine in the target media access service area that is connected to the target streaming media, so that the retrieving machine can pull a target media stream from a source media access machine according to an address of the source media access machine to which a streamer client of the target streaming media is connected. The retrieving machine distributes the target media stream to the media access machine in the target media access service area that is connected to the target streaming media.

In some embodiments, the distributing module is further configured to receive a streaming media management allocation request sent from the second-level streaming media management server in the target media access service area; and select a first-level streaming media management server that is allocated for the second-level streaming media management server from the first-level streaming media management servers that are not shut down according to the load status indicated by the first-level streaming media information from each first-level streaming media management server, in response to the streaming media management allocation request, where the streaming media management allocation request is a request sent when the second-level streaming media management server in the target media access service area verifies that the first-level streaming media management server is shut down. An address of the allocated first-level streaming media management server is sent to the second-level streaming media management server and each media access machine corresponding to the target media access service area, such that the second-level streaming media management server and each media access machine corresponding to the target media access service area migrate the number of streaming media and the number of connected objects served by the target media access service area to the first-level streaming media management server according to the address.

All or some of the modules in the data transmission apparatus can be implemented by software, hardware, and a combination thereof. The above modules can be built as hardware in or independent of a processor in a computer device, or can be stored as software in a memory of the computer device, so that the processor can invoke and execute the operations corresponding to the above modules.

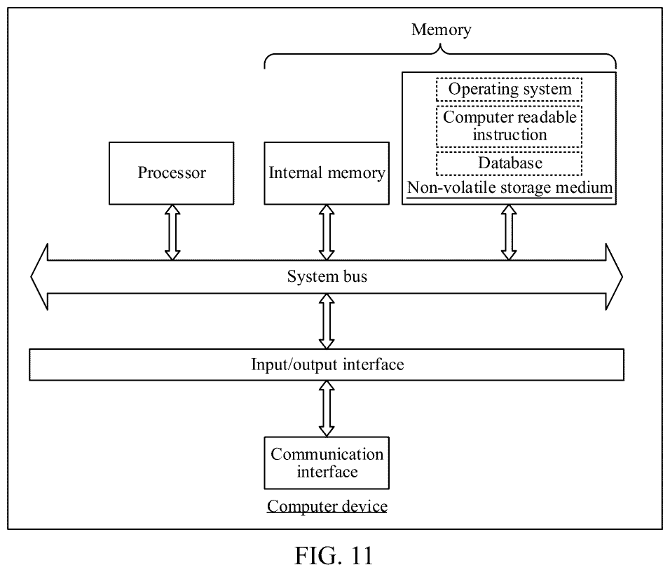

In an embodiment, a computer device is provided. The computer device may be a server or a terminal, having an internal structure as shown in FIG. 11. The computer device includes a processor, a memory, an input/output (I/O) interface, and a communication interface. The processor, the memory and the input/output interface are connected through a system bus, and the communication interface is connected to the system bus via the input/output interface. The processor of the computer device is used to provide the calculation and control abilities. The memory of the computer device includes a non-volatile storage medium and an internal memory. An operating system, a computer readable instruction, and a database are stored in the non-volatile storage medium. The internal memory provides an environment for the operation of the operating system and the computer readable instruction in the non-volatile storage medium. The input/output interface of the computer device is configured to exchange information between the processor and external devices. The communication interface of the computer device is configured to communicate with an external terminal through network connection. The computer readable instruction is executed by a processor to implement the data transmission method.

Those skilled in the art can understand that the structure shown in FIG. 11 is only a block diagram of part of the structure related to the solution of this application, and does not constitute a limitation on the computer device to which the solution of this application is applicable. The specific computer device may include more or fewer members than shown in the figure or include combinations of some members, or have a different arrangement of members.

In an embodiment, a computer device is further provided, including: a memory and a processor. The memory stores computer-readable instructions. When the computer-readable instructions are executed by the processor, the operations in the method embodiments above are implemented.

In an embodiment, a computer readable storage medium is provided, on which computer-readable instructions are stored. When the computer-readable instructions are executed by a processor, the operations in the method embodiments above are implemented.

In an embodiment, a computer program product is provided, which include computer-readable instructions. When the computer-readable instructions are executed by a processor, the operations in the method embodiments above are implemented.

The user information (including, but not limited to, the user equipment information, and the user personal information, etc.) and data (including, but not limited to, data for analysis, stored data, and presented data, etc.) involved in this application are all information and data authorized by the users or fully authorized by all parties. The collection, use and processing of relevant data need to comply with relevant laws, regulations and standards of relevant countries and regions.

Those of ordinary skill in the art can understand that all or part of the processes implementing the above-described methods in the embodiments can be implemented by a computer readable instruction instructing relevant hardware. The computer readable instruction may be stored in a non-volatile computer readable storage medium. When the computer readable instruction is executed, the processes of the methods in above-mentioned embodiments are implemented. Any reference to the memory, database or other media used in the embodiments provided in this application includes at least one of a non-volatile or a volatile memory. The non-volatile memory may include a read only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), and a graphene memory, etc. The volatile memory may include random access memory (RAM) or external cache memory. For the purpose of illustration but not limitation, RAM is available in many forms, for example, static random access memory (SRAM) or dynamic random access memory (DRAM), and so on. The databases involved in the embodiments provided in this application may include at least one of relational databases and non-relational databases. Non-relational databases may include, but are not limited to, distributed databases based on blockchain. The processors involved in the embodiments provided in this application can be, without limitation, general-purpose processors, central processing units, graphics processing units, digital signal processors, programmable logics, and data processing logics based on quantum computing, etc.

The technical features in the above-described embodiments can be combined at will, and for the brevity of description, not all possible combinations of the technical features in the above-mentioned embodiments are described. However, the combinations of these technical features are to be construed as falling within the scope of the present application as long as there are no contradictions.

In this disclosure, the phrases “at least one of A, B, and C” and “at least one of A, B, or C” both mean only A, only B, only C, or any combination of A, B, and C.

The above embodiments are only several implementations of the present application, and are described in detail, which, however, are not to be construed as a limitation to the scope of the present disclosure. For a person of ordinary skill in the art, several variations and improvements can be made without departing from the idea of the present disclosure, which are all contemplated in the protection scope of the present disclosure. Therefore, the protection scope of this application shall be defined by the appended claims.

What is claimed is:

1. A data transmission method, performed by a computer device, comprising:
obtaining an allocation request of a client for a media access machine;
in response to the allocation request, determining, from a plurality of media access service areas and according to first-level load information of each of the media access service areas, a target media access service area to which the client is to be connected;
determining, from a plurality of media access machines corresponding to the target media access service area and according to second-level load information of the target media access service area, a target media access machine to which the client is to be connected; and
allocating the target media access machine to the client for media data transmission between the client and the target media access machine.

2. The method according to claim 1, further comprising:
receiving the first-level load information pushed by a first-level load management server;
wherein:
the first-level load information is obtained by the first-level load management server based on the second-level load information corresponding to each media access service area, and includes a number of connected objects and a number of connected streaming media served by each media access service area, and a media access resource corresponding to each media access service area; and
the second-level load information is pushed by a second-level load management server to the first-level load management server, and includes a number of connected objects and a number of connected streaming media served by a corresponding media access service area, and a media access resource corresponding to the corresponding media access service area.

3. The method according to claim 1, further comprising:
receiving first-level streaming media information pushed by a first-level load management server, the first-level streaming media information being queried by the first-level load management server from a first-level streaming media management server.

4. The method according to claim 3, wherein:
the first-level streaming media information is obtained by the first-level streaming media management server based on second-level streaming media information corresponding to each media access service area, and includes a total number of streaming media served by the media access service areas and a number of connected objects connected to each streaming media; and
the second-level streaming media information is pushed by a second-level streaming media management server to the first-level streaming media management server, and includes a number of streaming media and a number of connected objects served by a corresponding media access service area.

5. The method according to claim 1,
wherein the allocation request further carries a streaming media identifier for identifying a target streaming medium;
the method further comprising:
determining that the client is connected to the target streaming media in response to that the target media access machine verifies, according to the streaming media identifier, that the target media access machine, a second-level streaming media management server in the target media access service area, and a first-level streaming media management server corresponding to the second-level streaming media management server are all connected to the target streaming media, the target media access machine being in the target media access service area.

6. The method according to claim 5, further comprising:
in response to determining, via the target media access machine and according to the streaming media identifier, that the target media access machine is not connected to the target streaming media, saving, via the target media access machine, the streaming media identifier to connect the target media access machine to the target streaming media, and querying, according to the streaming media identifier, whether the second-level streaming media management server in the target media access service area is connected to the target streaming media; and
determining that the client is connected to the target streaming media in response to determining that the second-level streaming media management server is connected to the target streaming media.

7. The method according to claim 6, further comprising:
in response to determining that the second-level streaming media management server is not connected to the target streaming media, saving, via the second-level streaming media management server, the streaming media identifier to connect the second-level streaming media management server to the target streaming media, and querying, according to the streaming media identifier, whether the corresponding first-level streaming media management server is connected to the target streaming media;
determining that the client is connected to the target streaming media in response to determining that the first-level streaming media management server is connected to the target streaming media; and
in response to determining that the first-level streaming media management server is not connected to the target streaming media, allocating a first-level streaming media management server for the target streaming media, and determining that the client is connected to the target streaming media after saving the streaming media identifier via the allocated first-level streaming media management server.

8. The method according to claim 5,
wherein the client is a client uplinking data;
the method further comprising, after the client is connected to the target streaming media:
generating a notification signaling about a streamer via the target media access machine, the notification signaling carrying the streaming media identifier of the target streaming media;
sending, via the target media access machine, the notification signaling to the first-level streaming media management server corresponding to the second-level streaming media management server, through the second-level streaming media management server in the target media access service area;
sending, via the first-level streaming media management server, the notification signaling to the second-level streaming media management server storing the streaming media identifier in each media access service area, and sending, via each second-level streaming media management server, the notification signaling to media access machine storing the streaming media identifier in the corresponding media access service area; and
sending, via the media access machine, the notification signaling to the client connected to the target streaming media.

9. The method according to claim 5,
wherein the client is a client downlinking data;
the method further comprising, after the client is connected to the target streaming media:
determining, via the target media access machine, a retrieving machine in the target media access service area that is connected to the target streaming media, so that the retrieving machine pulls a target media stream from a source media access machine according to an address of the source media access machine to which a streamer client of the target streaming media is connected; and
distributing, via the retrieving machine, the target media stream to the media access machine in the target media access service area that is connected to the target streaming media.

10. The method according to claim 1, further comprising:
receiving a streaming media management allocation request sent from the second-level streaming media management server in the target media access service area;
in response to the streaming media management allocation request, selecting a first-level streaming media management server that is allocated for the second-level streaming media management server from first-level streaming media management servers that are not shut down according to a load status indicated by the first-level streaming media information from each first-level streaming media management server, the streaming media management allocation request being a request sent when the second-level streaming media management server in the target media access service area verifies that the first-level streaming media management server is shut down; and
sending an address of the allocated first-level streaming media management server to the second-level streaming media management server and each media access machine corresponding to the target media access service area, such that the second-level streaming media management server and each media access machine corresponding to the target media access service area migrate the number of streaming media and the number of connected objects served by the target media access service area to the first-level streaming media management server according to the address.

11. A non-transitory computer-readable storage medium, storing computer executable instructions that, when executed by one or more processors, cause the one or more processors to perform the method according to claim 1.

12. A data transmission system comprising:
a client;
a scheduling server;
a first-level load management server; and
a second-level load management server located in each of one or more media access service areas determined by division according to geographical region;
wherein:
the second-level load management server located in each media access service area is configured to push second-level load information of the corresponding media access service area to the first-level load management server;
the first-level load management server is configured to push first-level load information corresponding to each media access service area to the scheduling server; and
the scheduling server is configured to:
obtain an allocation request of a client for a media access machine;
in response to the allocation request, determine, from a plurality of media access service areas and according to first-level load information of each of the media access service areas, a target media access service area to which the client is to be connected;
determine, from a plurality of media access machines corresponding to the target media access service area according to the second-level load information of the target media access service area, a target media access machine to which the client is to be connected; and
allocate the target media access machine to the client for media data transmission between the client and the target media access machine.

13. A computer device comprising:
one or more processors; and
one or more memories storing one or more program instructions that, when executed by the one or more processors, cause the one or more processors to:
obtain an allocation request of a client for a media access machine;
in response to the allocation request, determine, from a plurality of media access service areas and according to first-level load information of each of the media access service areas, a target media access service area to which the client is to be connected;
determine, from a plurality of media access machines corresponding to the target media access service area and according to second-level load information of the target media access service area, a target media access machine to which the client is to be connected; and
allocate the target media access machine to the client for media data transmission between the client and the target media access machine.

14. The computer device according to claim 13, wherein:
the one or more program instructions, when executed by the one or more processors, further cause the one or more processors to receive the first-level load information pushed by a first-level load management server;
the first-level load information is obtained by the first-level load management server based on the second-level load information corresponding to each media access service area, and includes a number of connected objects and a number of connected streaming media served by each media access service area, and a media access resource corresponding to each media access service area; and
the second-level load information is pushed by a second-level load management server to the first-level load management server, and includes a number of connected objects and a number of connected streaming media served by a corresponding media access service area, and a media access resource corresponding to the corresponding media access service area.

15. The computer device according to claim 13, wherein the one or more program instructions, when executed by the one or more processors, further cause the one or more processors to:
receive first-level streaming media information pushed by a first-level load management server, the first-level streaming media information being queried by the first-level load management server from a first-level streaming media management server.

16. The computer device according to claim 15, wherein:
the first-level streaming media information is obtained by the first-level streaming media management server based on second-level streaming media information corresponding to each media access service area, and includes a total number of streaming media served by the media access service areas and a number of connected objects connected to each streaming media; and
the second-level streaming media information is pushed by a second-level streaming media management server to the first-level streaming media management server, and includes a number of streaming media and a number of connected objects served by a corresponding media access service area.

17. The computer device according to claim 13, wherein:
the allocation request further carries a streaming media identifier for identifying a target streaming medium; and
the one or more program instructions, when executed by the one or more processors, further cause the one or more processors to:
determine that the client is connected to the target streaming media in response to that the target media access machine verifies, according to the streaming media identifier, that the target media access machine, a second-level streaming media management server in the target media access service area, and a first-level streaming media management server corresponding to the second-level streaming media management server are all connected to the target streaming media, the target media access machine being in the target media access service area.

18. The computer device according to claim 17, wherein the one or more program instructions, when executed by the one or more processors, further cause the one or more processors to:
in response to determining, via the target media access machine and according to the streaming media identifier, that the target media access machine is not connected to the target streaming media, save, via the target media access machine, the streaming media identifier to connect the target media access machine to the target streaming media, and query, according to the streaming media identifier, whether the second-level streaming media management server in the target media access service area is connected to the target streaming media; and
determine that the client is connected to the target streaming media in response to determining that the second-level streaming media management server is connected to the target streaming media.

19. The computer device according to claim 18, wherein the one or more program instructions, when executed by the one or more processors, further cause the one or more processors to:
in response to determining that the second-level streaming media management server is not connected to the target streaming media, save, via the second-level streaming media management server, the streaming media identifier to connect the second-level streaming media management server to the target streaming media, and query, according to the streaming media identifier, whether the corresponding first-level streaming media management server is connected to the target streaming media;
determine that the client is connected to the target streaming media in response to determining that the first-level streaming media management server is connected to the target streaming media; and
in response to determining that the first-level streaming media management server is not connected to the target streaming media, allocate a first-level streaming media management server for the target streaming media, and determining that the client is connected to the target streaming media after saving the streaming media identifier via the allocated first-level streaming media management server.

20. The computer device according to claim 17, wherein:
the client is a client uplinking data; and
the one or more program instructions, when executed by the one or more processors, further cause the one or more processors to, after the client is connected to the target streaming media:
generate a notification signaling about a streamer via the target media access machine, the notification signaling carrying the streaming media identifier of the target streaming media;
send, via the target media access machine, the notification signaling to the first-level streaming media management server corresponding to the second-level streaming media management server, through the second-level streaming media management server in the target media access service area;
send, via the first-level streaming media management server, the notification signaling to the second-level streaming media management server storing the streaming media identifier in each media access service area, and sending, via each second-level streaming media management server, the notification signaling to media access machine storing the streaming media identifier in the corresponding media access service area; and
send, via the media access machine, the notification signaling to the client connected to the target streaming media.
